(19) United States
(12) Patent Application Publication
(10) Pub. No.: US 2005/0096934 A1
(43) Pub. Date: May 5, 2005

(54) Part lifetime managing system

(76) Inventors: Yasuo Wakui, Tokyo (JP); Masayoshi Uchida, Tokyo (JP); Shoichi Ohtaka, Tokyo (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/949,891

(22) Filed: Sep. 27, 2004

(30) Foreign Application Priority Data
Sep. 30, 2003 (JP) 342435/2003
Nov. 26, 2003 (JP) 395907/2003
Sep. 30, 2003 (JP) 342365/2003
Sep. 30, 2003 (JP) 342496/2003
Dec. 1, 2003 (JP) 402229/2003

(51) Int. Cl. G06F 17/60

(52) U.S. Cl. 705/1

(57) ABSTRACT

The part lifetime management system includes a parts server and a parts lifetime managing server. Parts server stores various data of parts used to repair car, automobile, etc. When the drawing of a repair part is released, future integration plan of the part is decided and inputted to the parts lifetime managing server with an integration condition. In the future, when the integration condition is satisfied, the parts lifetime managing server outputs the instruction to integrate a part to predetermined terminal. Then, the supply of a pre-integration part is stopped and changed to post-integration part so that the number of kinds of repair parts are reduced.

### BACKGROUND OF THE INVENTION

1. Field of the Invention

The present invention relates to a technique for managing a part. More particularly, the present invention relates to a technique for managing the repair parts whose kinds are enormous.

2. Description of the Related Art

The mechanical products exemplified as a car, a two-wheeled vehicle and a general product (a product using an internal-combustion engine, such as an electric generator, a cultivator, an outboard engine or the like) are used for a long period. For this reason, the maker performs the support over the long period on the user buying it. For the support, the maker manages the repair parts. The maker prepares the part list indicating the list of the parts to be provided to the market as the repair parts, and makes it available for the general public perusal of a client or dealer.

The numbers of the parts used in those mechanical products are enormous. Moreover, because of the functions of the parts or the regulations resulting from the laws, it is necessary to carry out the complex business to manage which part is used as the repair part.

With reference to FIG. 1, it shows the part list of a key cylinder set used in an automobile. The symbols J1, J2 to J8 indicate the parts that are individually provided to a market.

For example, the user can order the glove box cylinder J12 as a single unit. The user can also order the steering lock assembly J2 including the glove box cylinder J12. The user can also order the key cylinder set J1 including the steering lock assembly J2. Such parts are provided to the market while they have various manners. Correspondingly to each of the parts exemplified as the key cylinder set J1, the steering lock assembly J2 to the screw J18 shown in FIG. 8, the integrated set of the data used by the maker in order to manage those parts is referred to as a selling account or an account in this specification. The maker manages many selling accounts by using a database stored in an electronic memory medium.

A part managing method is known for constituting respective models of respective specified products and dividing into a plurality of units that can be used in at least one model and registering, and then registering at least one part constituting the unit in the lower layers of those units, and then when receiving the order of the product, selecting and combining the units in response to this ordered content, and consequently preparing the part model table of the product (Japanese Laid Open Patent Application (JP-A, 2003-228408)).

A change history managing apparatus of a part configuration information for carrying out a history management based on a design change of hierarchically configured parts is known which is characterized by including: a part information storing unit for storing a part information containing a part identification code to identify a part; a part configuration information storing unit for storing a part configuration information containing a part identification code and a part identification code of a slave part of the part; a part history information storing unit for storing a part history information containing a part identification code, a change history and a design change timing for each design-changed part; a part identification code specifying unit for specifying a particular part identification code; a part information obtaining unit for extracting a part information having the specified part identification code from the part information storing unit; a part configuration information obtaining unit for extracting a part configuration information having the specified part identification code from the part configuration storing unit; and apart history information obtaining unit for extracting a part history information having a predetermined design change timing from the part history information having the specified part identification code, which is stored in the part history information storing unit (Japanese Laid Open Patent Application (JP-A-Heisei, 11-66139).

A system combination situation managing apparatus of a combination system in which various kinds of devices and functions that are produced by a maker side are suitably combined by a user side is characterized by: providing a member specification code storing unit that for an individual combination member of the combination system, generally stores a code, from which the member can be specified, such as a manufacturing maker name, a type, a manufacture number or the like of the member, with regard to the combination system; providing a particular code registering unit for registering the particular code in accordance with a new installation of each member, in the member specification code storing unit and a code deleting unit for deleting the registration code in association with a disposal of each member; and providing a registration content outputting unit for suitably outputting a present registration content of the member specification code storing unit (Japanese Laid Open Patent Application (JP-A-Heisei, 4-57139).

### SUMMARY OF THE INVENTION

The number of the accounts (namely, the number sold as the repair parts) may be very enormous. In that case, the suppression in the number of the accounts is desired to suppress the cost required to manage the repair parts, such as the holding cost of the stock and the like.

In order to suppress the number of the accounts, it is effective to integrate the repair parts. The integration of the repair parts indicates the tasks to reduce the number of the accounts by using the manners as exemplified below.

(1) If there are several kinds of parts which are equal in the mechanical function although their colors are different, the account for the part of one kind should be left among them, and the other accounts should be removed.

(2) If there is a part having the compatibility higher than a certain part, the account for the certain part should be removed, and the account for the part having the higher compatibility should be left.

(3) The selling accounts for both of a certain part and a set partially containing the part are established, the selling account for the part should be removed, and only the selling account for the set should be left.

In order to suppress the number of the accounts, it is effective to carry out the selling stop. The selling stop indicates the task to stop selling the part by using the manners exemplified below and make the account for the part invalid.

(4) If the part is the part that a user can easily obtain from a market (for example, a battery, a bulb, a seal kind, a vinyl product), the selling of the part should be stopped.

(5) As for a part whose account number can be reduced by changing the configuration of the part, the manner of the configuration (hereafter, referred to as a selling manner change) is performed thereon. For example, in the case of the two-wheeled vehicle, when there are four kinds of cowlings and five kinds of stripes, if the cowlings with the stripes are sold under all combinations, the number of the accounts becomes 4×5=20 kinds. On the other hand, if the stripes and the cowlings are separately sold, the number of the accounts becomes 4×5=9 kinds. If there are many user needs, it is desired that such parts are supplied as the cowling with the stripe, and if the user needs are dropped, the stripes and the cowlings are separately sold. As a result, the number of the kinds of the cowlings that are large in volumes can be reduced from 20 kinds to 4 kinds, which are desirable from the viewpoints of the management of the parts.

(6) As for the part which is judged not to have the motivation of a user purchase (for example, in a case that a price of a certain part becomes a price evidently exceeding a price of a used car similar to that of a vehicle used by a user) because of the aged deterioration in a car age or a value sense of the user, the selling thereof should be stopped after the elapse of years. Such a case exists in a floor panel or a frame of the two-wheeled vehicle.

The maker, when receiving the order of the part of the removed account, gives the information of the part of the left account to the ordering person. In this specification, the removed account is referred to as the pre-integration, the left account is referred to as the post-integration, and the account of the pre-integration is said to be integrated into the account of the post-integration.

The subject to be solved by the present invention is to provide a part lifetime managing system for simplifying a management of repair parts for a long period.

Another subject to be solved by the present invention is to provide a part lifetime managing system for easing a task to reduce the number of the accounts of the repair parts.

Still another subject to be solved by the present invention is to provide a part lifetime managing system for easing a task to reduce the kinds of the repair parts.

Still another subject to be solved by the present invention is to provide a part lifetime managing system for predetermining and managing a schedule of a future part management at a time of a part design.

Still another subject to be solved by the present invention is to provide a part lifetime managing system that can specify a proper proxy part in accordance with a design change of a part.

Still another subject to be solved by the present invention is to provide a part lifetime managing system that, when the repair parts are integrated by using the part lifetime managing system, properly copes with a query of a sales situation, with regard to the integrated parts, which is required by a client.

In an aspect of present invention, a parts lifetime management system includes a parts server which stores a parts database storing a plurality of records corresponding to a plurality of kinds of parts which are commercially available, each of the plurality of records including a part ID to specify a corresponding one of the plurality of kinds. The parts lifetime management system further includes a parts lifetime managing server which is connected to the parts server by a communication line and which stores an integration database storing an integration data which relates to a pre-integration part ID, a post-integration part ID and an integration condition, wherein the pre-integration part ID and the post-integration part ID are extracted from among the plurality of part Ids. When the integration condition is satisfied, the parts life time managing server includes an updating unit which generates and transmits an update notice to the parts server such that it is notified to the parts server that a supply of a previous part specified by the pre-integration part ID is stopped and the pre-integration part is changed to a post-integration part specified by the post-integration part ID and the parts database is updated.

Managing repair parts using this system, the planning operations like the integration (which means stopping a certain kind of part and changes to the another part) or the selling stop is simplified. After the integration or the selling stop, the labor and the cost decreases, for example the die of that part can be discarded.

Preferably, the integration information is inputted to the integration database in a short period after a part is designed, for example, in a few days or in a few weeks, or before the product using the part is shipped. In a short period after a part is designed, it is easy to get the detailed data of the part from the designer or the maker which designs the part. Therefore, it is easy to consider the integration of the part is possible or not. So the future integration can be set in a short time. As a result, the cost to manage parts in a long period is reduced. Further, it is easy to guarantee the high quality of the integrated parts.

Further, updating unit updates an integration information make it possible to change an integration plan of parts at any time in response to a revision of parts, needs in the market, or a policy of the maker. Such a parts lifetime management system is preferably used for parts which needs a long time support.

Moreover, the lifetime management system according to the present invention, the life time managing server requests to input a specified date and a specified period in response to an input of the integration data, and stores the specified date and the specified period correspondently in the integration database, and calculates a date after the specified period from the specified date as an execution date, and outputs the update notice to the parts server on the execution date such that the pre-integration part specified by the pre-integration part ID of the integration data is replaced by the post-integration part specified the post-integration part ID of the integration data.

Moreover, the parts lifetime management system according to the present invention, the lifetime managing server receives a change request of the specified date through the communication line, requests an input of a new specified date and a new specified period in response to a reception of the change request, and stores the new specified date and the new specified period in the integration database, and calculates a date after the new specified period from the new specified date as a new execution date, sets the new execution date as a date when the pre-integration part specified by the pre-integration part ID is changed to the post-integration part specified by the post-integration part ID.

In a parts lifetime management system according to the present invention, an integration condition indicates a predetermined period is expired. By such a parts lifetime management system, for example, it is possible to set integration plan just after a part is designed and after 10 years the integration information is reported to the operator. Further, the integration is executed by the integration plan which is established at the time when it is easy to collect information about the design of parts, the efficiency of the integration operation becomes high and operation becomes accurate.

From the time that the mass production is ended (there is possibility that the time is changed by the demand to a product or the policy of a supplier) until a few years after, the demand of the repair parts of the product is high generally. Therefore, the integration condition is preferred to set the time a predetermined years is expired from the date that the mass production is ended as the initial date in reckoning. In this case, the integration condition indicates a period from the mass production of the product to which a part specified by the before integration parts ID is expired.

The present invention has the effect that when the repair parts used to repair the product supplied to a market are managed, the future part managing program can be planned in designing the part, which can greatly reduce the labor to manage the repair parts.

Moreover, the parts lifetime management system according to the present invention, the parts lifetime managing server outputs the post-integration part ID corresponding to the pre-integration part ID stored in the integration database, when the pre-integration part ID stored in the integration database is received from a predetermined terminal through the communication line and the integration condition corresponding to the pre-integration part ID stored in the integration database is met.

Moreover, the parts lifetime management system according to the present invention, the integration database stores with respect to the part ID, a supply period data indicating a supply period for which each of the parts specified by the part ID should be supplied on a market, and the part ID includes a caution part ID of a caution part that there is a possibility that a supply to a market is stopped before the supply period is expired, and when an inquiry including the part ID is sent from a predetermined terminal, if the inquired part ID is the caution part ID, the parts server notifies that a part specified by the inquired part ID is the caution part ID, to the predetermined terminal.

In a 10 years or more from the design of a part, integration plan or sales plan can be changed. For example, the integration of a part has been planned but could not help stopping sale. Even under such a circumstance, a lifetime management system according to the present invention can easily revise an integration plan.

Moreover, the parts lifetime management system according to the present invention, the integration data is inputted to the integration database when a design drawing of the parts is released.

Moreover, the parts lifetime management system according to the present invention, the parts are used to repair an automobile, a motorbike, or a general purpose machine of a generator, a tiller, an outboard engine, or a lawn mower.

Moreover, the parts lifetime management system according to the present invention, the integration condition is a time period after a mass production of a product using the part specified by the pre-integration part ID is ended.

Moreover, the parts lifetime management system according to the present invention, the parts lifetime managing server sends an input screen data to an integration terminal to request an input of data when the integration condition is satisfied and executes an integration process using the data inputted from the input screen of the integration terminal, and the integration process includes at least one of a process invalidating any one of the records having the pre-integration part ID, a process changing the integration condition, and a process deleting the integration data from the integration database.

By using such a parts lifetime management system, when the condition in a parts integration plan is satisfied, it is reported automatically to a terminal operator. Therefore, the operator can be certainly reported the coming of the integration. Further, for the input screen about an integration process is supplied to an operator, the integration process is executed after the check of an operator about market needs, regulations, and management policy of parts suppliers.

Moreover, the parts lifetime management system according to the present invention, further includes a changing unit which, when the pre-integration part ID is retrieved from a user terminal through the communication line, sends one of the records including the post-integration part ID corresponding to the retrieved pre-integration part ID.

By such a parts lifetime management system, after integration, when an inquiry about the integrated parts is reported, after integration parts is automatically introduced to the user terminal.

Moreover, the parts lifetime management system according to the present invention, the integration condition shows that a predetermined period is elapsed.

Moreover, the parts lifetime management system according to the present invention, the updating unit updates the integration data using a design revision data which indicates a design of a part is revised, when the design revision data is inputted to the parts database.

The mechanical products exemplified as a car, a two-wheeled vehicle and a general product (a product using an internal-combustion engine, such as an electric generator, a cultivator, an outboard engine or the like) are used for a long period. For this reason, the maker performs the support over the long period on the user buying it. Further, there are huge number of kinds of parts used for one product. Further, to manage a repair part, the function of the part or the regulation is related, therefore it becomes very complicated business. A parts lifetime management system according to the present invention is preferably used for this kind of complicated and long term management of the repair parts. The design of parts of mechanical products like a car, a two wheeled vehicle and a general product is often revised after the product is supplied to the market, therefore, parts lifetime management system which can easily change the integration plan is preferably used for such kind of mechanical products.

By such a parts integration system, when a part design is revised after a integration plan is set (preferably before part account is opened), an integration information is changed following the design revision. Therefore, the trouble that when planned integration is executed integration is impossible because of a design revision of a part is prevented. Such a parts lifetime integration system can be preferably used to the products that the period to an integration is long and part design is often revised like the mechanical products as a car, a two-wheeled vehicle and a general product.

Moreover, the parts lifetime management system according to the present invention, each of the records includes a demand data designating a demand of each one of the parts in a past predetermined period, and the updating unit collects the demand data when an integration time of the integration condition is met, and updates the integration condition when an amount of the demand is larger than a predetermined quantity.

By using such a parts lifetime management system, integration is not executed for a part which demand is relatively large. Namely, a part which has a certain needs in the market is not integrated and continued to supply.

Moreover, the parts lifetime management system according to the present invention, the parts server stores a design revision database storing design data of parts, and generates a design revision message including data of a part which is stored in the design management database and sends to the parts lifetime managing server when a design of apart is revised, and the parts lifetime managing server retrieves the integration database in response to a reception of the design revision message, and the parts lifetime managing server outputs a revision request to revise a correspondence between the pre-integration part ID and the post-integration part ID when the pre-integration part ID including any of design revisal planning parts corresponds to the design revised part.

Moreover, the parts lifetime management system according to the present invention, the design revision message includes interchangeability data indicating whether or not the design revised parts and the design revisal planning parts is interchangeable, and the parts lifetime managing server updates a correspondence of the pre-integration part ID and the post-integration part ID stored in the integration database using the interchangeability data when the pre-integration part ID or the post-integration part ID indicating the design revisal planning parts corresponding to the design revised parts is found in the integration database.

Moreover, the parts lifetime management system according to the present invention includes a client terminal installed in a plurality of service branches and connected to the parts server or the parts lifetime managing server through a wide area network, wherein the integration database stores a selling stop date set with designating at least one of the pre-integration part ID, a cause of selling stop showing a cause to stop a supply of a part corresponding to the pre-integration part ID in response to a coming of the selling stop date, and a code of a cause generated by coding the cause of selling stop, the parts server stops a supply of part corresponding to the pre-integration part ID designated in a coming of the selling stop date, and outputs the cause code in response to an inquiry about a part corresponding to stopped the pre-integration part ID from the user terminal, and the user terminal receives the cause code through the network and outputs it.

Moreover, the parts lifetime management system according to the present invention, the cause code includes an integration cause code and a selling stop cause code, and the parts lifetime managing server retrieves the integration database in response to an inquiry including the part ID from the client terminal, and when the post-integration part ID corresponding to the pre-integration part ID which is coincide with the inquired part ID is retrieved, the parts lifetime managing server outputs the post-integration part ID and the integration cause code, and when the post-integration part ID corresponding to the pre-integration part ID which is coincide with the inquired part ID is not retrieved, the parts lifetime managing server outputs the selling stop cause code, and the client terminal receives the outputted integration cause code or the selling stop cause code through a wide area network.

Moreover, the parts lifetime management system according to the present invention, the selling stop cause includes a cause of integration and a cause of supply stop, the parts lifetime managing server retrieves the integration database in response to an inquiry received from the client terminal with the part ID, and when the post-integration part ID corresponding to the pre-integration part ID coincides with the inquired part ID is retrieved, the parts lifetime managing server outputs the post-integration part ID, the integration cause code, and the cause of integration, and when the post-integration part ID corresponding to the pre-integration part ID which is coincide with the inquired part ID is not retrieved, the parts lifetime managing server outputs the selling stop cause code and a cause of supply stop, and the client terminal receives outputted the integration cause code or the selling stop cause code through a wide area network.

Moreover, the parts lifetime management system according to the present invention, the client terminal sends a cause of integration outputting request which corresponds the pre-integration part ID and the cause code through a wide area network to the parts server, and the parts server executes retrieving on the integration database in response to the cause of integration outputting request and reports the cause of selling stop extracted by the retrieving to the client terminal.

In another aspect of the present invention, a parts lifetime managing method in a parts lifetime management system includes a network, a parts server storing a parts database storing a plurality of records each of which corresponds to a kind of parts which are commercially available, and each of the plurality of records includes a part ID which specifies the kind of parts, and an integrated record which is a part of the plurality of records includes data that a supply of a part specified by the part ID is stopped and changed to a supply of an another part, and a parts lifetime managing server connected to the parts server by the network, and memorizing an integration database storing integration data which includes a pre-integration part ID and an post-integration part ID and a specified date and a specified period correspondingly, and the pre-integration part ID and the post-integration part ID are extracted from the part ID. The parts lifetime management method includes the steps of registering the part ID on the integration database as the pre-integration part ID when a design drawing of parts specified by the part ID is released, registering the part ID which specifies a part interchangeable to a part specified by stored the pre-integration part ID on the integration database as the post-integration part ID, registering the specified date and the specified period to the integration database, calculating a date after the specified period from the specified date as an execution date, sending the pre-integration ID and the post-integration ID from the parts lifetime managing server to the parts server in response to a coming of the execution date, and updating the parts database to change a supply of a part specified by received the pre-integration ID to a supply of a part specified by received the post-integration ID.

Moreover, the parts lifetime managing method of a parts lifetime management system according to the present invention includes the steps of sending specified date changing data which reports a change of the specified date from a predetermined terminal to the parts lifetime managing server, requesting a new specified date and a new specified period from the predetermined terminal to an operator in response to receiving the specific date change data, storing the new specified date and the new specified period inputted in response to the requesting to the integration database, calculating a new date after the new specified period from the new specified date as an new execution date, and storing the new execution date to the integration database.

Moreover, the parts lifetime managing method according to the present invention includes the steps of inquiring about a part from the predetermined terminal to the parts server, sending data to the predetermined terminal in a case that the record corresponding to inquired the part is the integrated record, a report which indicates a supply of the part specified by the pre-integration part ID included in the integrated record is stopped and changed to a supply of a part specified by corresponding the post-integration part ID is generated and sent to the predetermined terminal.

Moreover, the parts lifetime managing method according to the present invention includes the steps of storing supply period data indicating a supplying period of each of the parts to a market to the parts lifetime managing server, storing a part ID indicating a part whose supply to a market might be stopped before the supplying period is expired as a caution part to the parts server, storing the caution part in the parts lifetime managing server when a design of the caution part is released, inquiring about the part from a predetermined terminal, and replying to the predetermined terminal that inquired the part is the caution part if inquired the part is the caution part.

Moreover, the parts lifetime managing method according to the present invention, a parts server stores a design management database which stores designs of parts, and the parts lifetime management method includes the steps of requiring a specified date and a specified period in response to an input of the integration data, storing inputted the specified date and the specified period correspondingly to the integration database, calculating a date after the specified period from the specified date as an execution date in response to the storing of the specified date and the specified period, generating a design revision message reporting a pre-revised parts whose data is stored in the design management database is revised to a post-revised parts, adding interchangeability data representing an interchangeability of the pre-revised parts and the post-revised parts to the design revision message, sending the design revision message to the parts lifetime managing server, retrieving the integration database in response to receiving the design revision message, changing a relation between the pre-integration part ID and the post-integration part ID in the integration database based on the interchangeability data in the case that as a result of the retrieving, the pre-integration part ID or the post-integration part ID includes the pre-revised parts corresponding to the post-revised parts is found, and sending an updating request data which requests a relation of the pre-integration part ID and the post-integration part ID to be updated to an operator terminal, in a case that as a result of the retrieving, the pre-integration part ID or the post-integration part ID includes the pre-revised parts corresponding to the post-revised parts is found.

Moreover, the parts lifetime managing method according to the present invention includes the steps of requesting an approval data which indicates a changing of correspondence of parts is approved or not to the operator terminal when the operator terminal receives the updating request data, sending the approval data from the operator terminal to the parts lifetime managing server, and deciding the pre-integration part ID and the post-integration part ID to be changed or not based on the approval data by the parts lifetime managing server.

Moreover, the parts lifetime managing method according to the present invention, a parts server stores a design management database which stores designs of parts, and the operation method further comprises the steps of inputting a specified date and a specified period and a pre-integration part ID which indicates a kind of the parts, and post-integration part ID which specifies a part interchangeable to a part specified by the pre-integration part ID when a design draft is released, calculating a date after the specified period from the specified date as an execution date, stopping a supply of a part specified by the pre-integration part ID in response to a coming of the execution date, storing a selling stop date corresponds to the pre-integration part ID, a cause of selling stop which explains a cause to stop a supply of parts corresponding to the pre-integration part ID in response to a coming of the selling stop date, and a code of a cause which is generated by coding the cause of selling stop to the parts lifetime managing server, stopping a supply of part specified by the pre-integration part ID in response to a coming of the selling stop date, and outputting the cause of selling stop in response to an inquiry about a supply stopped parts.

Moreover, the parts lifetime managing method according to the present invention, wherein the code of a cause includes an integration cause code and a selling stop cause code, and the parts lifetime managing method includes the steps of retrieving the integration database in response to an inquiry of a supply stopped part, outputting the post-integration part ID and the integration cause code in a case that as a result of the retrieving the post-integration part ID corresponding to the part ID of the supply stopped part is found, and outputting the selling stop cause code in a case that as a result of the retrieving the post-integration part ID corresponding to the part ID of the supply stopped parts is not found.

Moreover, the parts lifetime managing method according to the present invention, the cause of selling stop includes a cause of integration and a cause of supply stop, and the operating method includes the steps of retrieving the integration database in response to an inquiry of a supply stopped part, outputting the post-integration part ID and the cause of integration and the integration cause code in a case that as a result of the retrieving the pre-integration part ID of the supply stopped part is found, outputting the cause of supply stop and selling stop cause code in a case that as a result of the retrieving the pre-integration part ID of the supply stopped parts is not found, and outputting a set of the cause of integration and the integration cause code, or a set of the cause of supply stop and the selling stop cause code.

To operate a parts lifetime management system as mentioned above, the setting operation of the integration of a part is simplified. Further, by operating a parts lifetime management system as mentioned above, even if the design is revised after the integration of a part, the occurrence of the improper integration is prevented.

The present invention still has the effect to simplify the management of the repair parts for a long period.

The present invention still has the effect to ease the task to reduce the kinds of the repair parts.

The present invention still has the effect that the schedule for the future part management can be predetermined and managed at the time of the part design.

The present invention still has the effect that the proper proxy part can be specified in accordance with the design change in the part.

The present invention still has the effect that the initial answer to the query from a client, which was conventionally difficult to execute, can be carried out suitably and easily.

The present invention still has the effect that with regard to the schematic explanation of the part selling situation to the client, even if there is the request of the further detailed explanation, the prompt action can be carried out, thereby increasing the client satisfaction.

### BRIEF DESCRIPTION OF THE DRAWINGS

FIG. 1 is a view explaining an account;

FIG. 2 schematically shows a task that is carried out by using a part lifetime managing system according to the present invention;

FIG. 3 shows a configuration of the part lifetime managing system;

FIG. 4 shows a configuration of a memory of a parts lifetime managing server;

FIG. 5 shows a configuration of a memory of a parts server;

FIG. 6 shows a configuration of a table;

FIG. 7 shows a configuration of a table;

FIG. 8 shows a configuration of a table;

FIG. 9 shows a configuration of a table;

FIG. 10 shows a configuration of a table;

FIG. 11 shows a configuration of a table;

FIG. 12A is a flowchart showing an integration timing and a selling stop timing setting operation;

FIG. 12B is a flowchart showing an integration timing and a selling stop timing setting operation;

FIG. 13 is a flowchart showing an operation for determining an integration execution date;

FIG. 14 is a flowchart showing an operation of a negotiation to a query with regard to an integrated account;

FIG. 15 is a flowchart showing an operation at a time of an order to the integrated account;

FIG. 16 is a view showing a configuration of a selling division table;

FIG. 17 is a view showing a configuration of a displaying screen displayed on an external terminal;

FIG. 18 is a view showing a configuration of a following logic table used for a manufacture stop following;

FIG. 19A shows a configuration of a following logic table used for a design change following;

FIG. 19B shows a configuration of a following logic table used for a design change following; and

FIG. 20 is a flowchart showing an operation of a design change following.

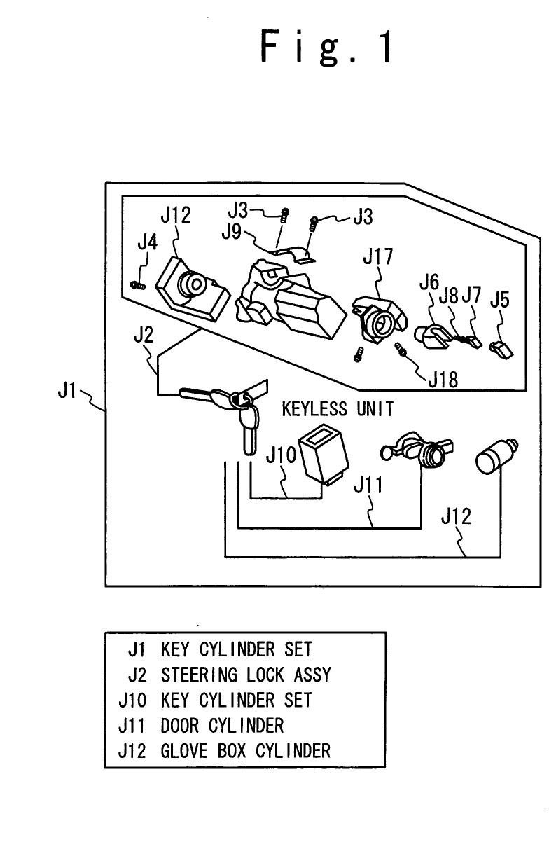

### DESCRIPTION OF THE PREFERRED EMBODIMENTS

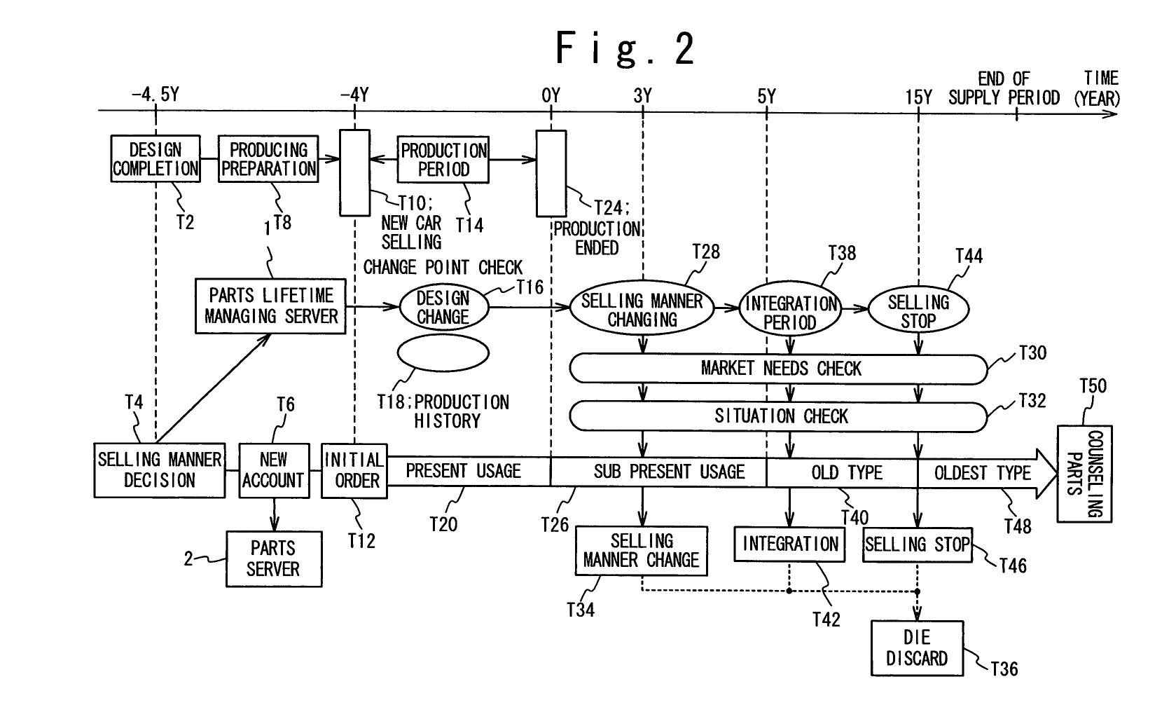

With reference to FIG. 2, it shows the entire diagram of the part managing task which is carried out by using the part lifetime managing system according to the present invention. The part lifetime managing system in this embodiment is used to manage the parts of the car of a particular model. The part lifetime managing system according to the present invention can be used to manage the repair parts of the two-wheeled vehicle, the general machine (the product using the internal-combustion engine, such as the electric generator, the cultivator, an outboard motor or the like) using an engine, or a product exemplified as a home electrical product.

In FIG. 2, the time point when the mass production of the product (car) is ended is represented by an origin (0Y) of a time. The number of the years after the mass production end is represented by a positive number (for example, [3Y] of FIG. 2 indicates the three years after the mass production end). The number of the years before the mass production end is represented by a negative number (for example, [−4Y] of FIG. 2 indicates the four years before the mass production end).

Before 4.5 years before the mass production end of the product, the design of the part used in the product is completed (Step T2). After the completion of the part design, the selling manner setting and the account reduction consideration (integration consideration) are executed. The account setting indicating the manner through which the part is sold is carried out on the basis of the selling manner setting. Whether or not a plurality of parts whose functions and appearances are close can be integrated into one type is considered on the basis of the integration consideration. Or, whether or not the parts, which are sold as a set and a single unit, are integrated into any one selling manner is considered. Or, whether or not any one of the parts sold as the set and the single unit is stopped and they are integrated into the other selling manner is considered (Step T4).

As the result of the integration consideration, as for the part determined to be integrated at a predetermined timing, for example, five years after the mass production end, the information with regard to the integration is registered in a parts lifetime managing server 1. Moreover, as the result of the integration consideration, as for the part whose selling is determined to be stopped at the predetermined timing, the information with regard to the selling stop is registered in the parts lifetime managing server 1.

As the result of the integration consideration, as for the part determined to be integrated into the other part when the product begins to be sold, the account is not newly established. Consequently, the parts under the same specification which are accumulated from a plurality of makers, the parts under the same specification although the labels are different, and the like are integrated.

As for the other parts, the accounts are newly established (Step T6). The newly established accounts are registered in a part managing server 2.

For the car after the design completion, the producing preparation is advanced (Step T8), and it is sold 0.5 years after (−4Y) (Step T10). When the car is sold, the order of the parts used in the car is started (Step T12).

The car is mass-produced for four years after the start of the selling (Step T14) The period while the car is mass-produced is a present usage period T20, and the part used in the car is referred to as a present usage.

If the design change in the part occurs in the present usage period T20, the integration information stored in the parts lifetime managing server 1 is changed correspondingly to the design change (Step T16). Moreover, if the manufacture period of the product to which the part is applied is changed, or if the information indicating whether or not the car to which the part is applied is actually manufactured is changed, the integration information stored in the parts lifetime managing server 1 is changed (Step T18).

The mass production of the car is ended four years after the start of the selling (0Y) (Step T24). The period of the five years after the mass production end is a sub present usage period T26, and the part used in the car is said to be sub present.

Three years after the mass production end (3Y), the parts lifetime managing server 1 reports to a responsible person the arrival of the timing of changing the predetermined selling manner (Step T28). The manner change implies, for example, that one selling manner of the set and the single unit is stopped and integrated into the other selling manner, or that the selling of the assembly part whose demand is small is stopped.

The responsible person receiving the report checks the needs of the market and judges whether or not the change in the selling manner is carried out on the basis of the demand amount of the part in a past predetermined period (Step T30). The responsible person further judges whether or not the part is available, and considers the policy of the maker, the related laws, the tendency of the market and the like, and judges whether or not the change in the selling manner is carried out (Step T32).

The responsible person, if judging that the selling manner may be executed on the basis of the market needs check T30 and the situation confirmation judgment T32, executes the change in the selling manner (Step T34). After the change in the selling manner, if there is a die whose necessity is lost, the die is discarded after the confirmation (Step T36).

Five years after the mass production end (5Y), the demand for the part of the car is gradually reduced. The period between 5 years and 15 years after the mass production end is an old type period T40, and the part used in the car is referred to as an old type.

After the elapse of the predetermined period after the part became the old type, the parts lifetime managing server 1 reports the responsible person the arrival of the timing of the preset integration (Step T38). The integration is carried out, for example, in such a way that although the materials and the colors are different, if there are a plurality of parts having the compatibility (or interchangeability), only some of the parts are left.

The responsible person receiving the report executes the market needs check (Step T30) and the situation confirmation judgment (Step T32) similarly to the manner change timing. As a result, if the responsible person judges that the integration should be executed, the integration is executed (Step T42). After the integration, if there is the die whose necessity is lost, the die is discarded after the confirmation (Step T36).

After the elapse of 15 years after the mass production end (15Y), the demand for the repair parts used in the car becomes very small. The period between the supply term and the 15 years after the mass production end is the oldest type period T48, and the part used in the car is referred to as the oldest type.

When the part becomes the oldest type, the parts lifetime managing server 1 reports the responsible person the arrival of the timing of carrying out the predetermined selling stop (Step T44). The selling stop is performed on the part having no functional or legal problem.

The responsible person receiving the report executes the market needs confirmation (Step T30) and the situation confirmation judgment (Step T32) similarly to the manner change timing. As a result, if the responsible person judges that the stop of the selling may be executed, the selling is stopped (Step T46). After the stop of the selling, if there is the die whose necessity is lost, the die is discarded after the confirmation (Step T36).

At the time of the supply term after the mass production end, the support period of the repair parts insured by the maker is ended. The part exceeding the supply term after the mass production end is referred to as a consultation part. If there is a query, the responsible person copes with it (Step T50).

The above-mentioned tasks are efficiently carried out under the assistance of the part lifetime managing system according to the present invention.

In the part managing system according to the present invention, the integration condition implies the elapse of the predetermined period, as mentioned above. According to the part managing system of the present invention, an integration plan is established, for example, when a certain part is designed. Then, the instruction of the integration of the parts can be reported to the responsible person 10 years after it. Moreover, in accordance with the integration plan determined at the time of the design at which the collection of the information with regard to the part design is easy, the integration is carried out, which consequently makes the integration task efficient and further makes the execution thereof accurate.

In the part managing system according to the present invention, in the several years from the time when the mass production was ended (because of the demand for the product and the operation policy of a supplier, there is the possibility of a change), the demand for the repair parts is high in many cases. For this reason, as the integration condition, it is desired to be established at the timing after the elapse of the predetermined number of years when it is calculated from the time of the mass production end. In this case, the integration condition implies the period after the elapse of the mass production end of the product using the part specified on the basis of a pre-integration part ID.

In this case, the period of about 10 years or more has been elapsed until the execution of the integration of the parts after the design of the part. At this time, it is difficult to examine the detailed design in order to integrate the parts. However, according to the part managing system of the present invention, since the integration plan of the parts prepared at the time of the design is reported, the integration task is executed easily and accurately.

In the part managing system according to the present invention, in the several years from the time when the mass production was ended (because of the demand for the product and the operation policy of the supplier, there is the possibility of the change), the demand for the repair parts is high in many cases. For this reason, as the integration condition, it is desired to be established at the timing after the elapse of the predetermined number of years when it is calculated from the time of the mass production end. In this case, the integration condition implies the period after the elapse of the mass production end of the product using the part specified on the basis of the pre-integration part ID.

In this case, the period of about 10 years or more has been elapsed until the execution of the integration of the parts after the design of the part. At this time, it is difficult to examine the detailed design in order to integrate the parts. However, according to the part managing system of the present invention, since the integration plan of the parts prepared at the time of the design is reported, the integration task is executed easily and accurately.

Correspondingly to the elapse of the period of about 10 years or more until the execution of the integration of the parts after the design of the parts, the occurrence of the plan change may be sufficiently considered. Even if the selling is forced to be stopped in spite of the plan of the integration, the part managing system of the present invention enables the integration plan of the parts prepared at the time of the design to be reported, which enables the integration task to be executed easily and accurately.

The configurations and operations of the part lifetime managing system for supporting the task as mentioned above will be described below in detail.

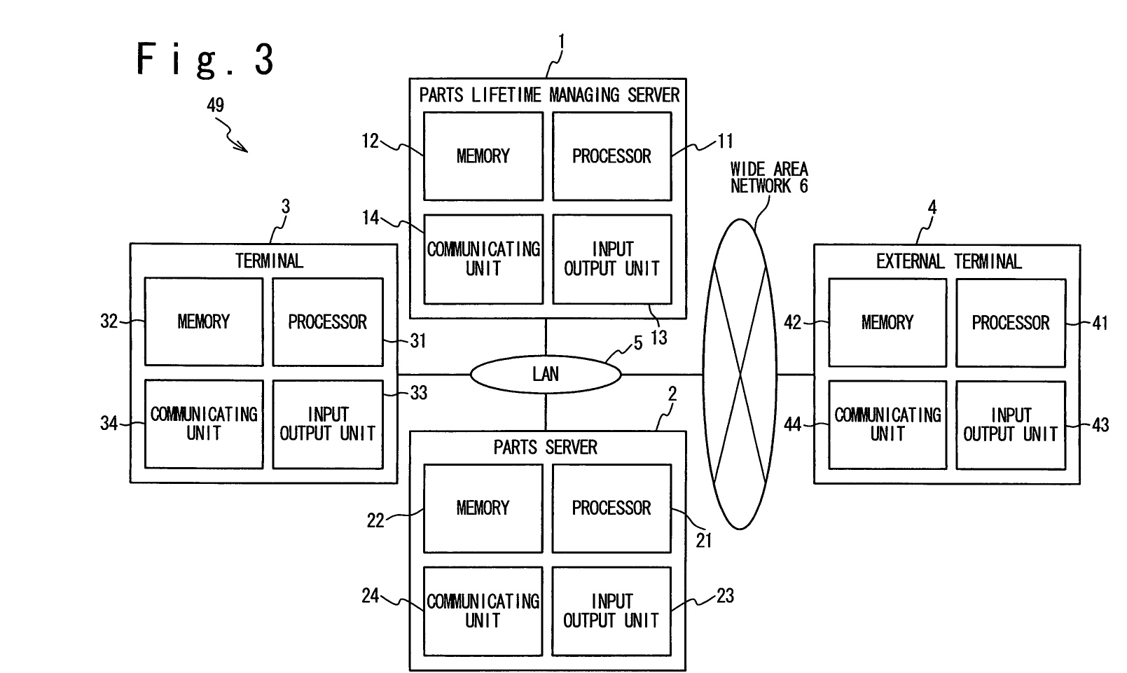

FIG. 3 shows the configuration in the best mode for carrying out the part lifetime managing system of the present invention. With reference to FIG. 3, a part lifetime managing system 49 of the present invention is provided with a parts lifetime managing server 1, a parts server 2, a terminal 3, an external terminal 4, a LAN (Local Area Network) 5 and a wide area network 6. The parts lifetime managing server 1 is the information processing terminal for storing the integration of the parts which will be possibly integrated in future. It is connected to the LAN 5 installed inside a part managing facility and carries out an information communication with the parts server 2 and the terminal 3 through the LAN 5. The parts lifetime managing server 1 further includes a processor 11, a memory 12, an input output unit 13 for inputting and outputting the information, and a communicating unit 14 for controlling the information communication to be carried out through the LAN 5.

The processor 11 is the operation processing function block installed in the parts lifetime managing server 1. It has a CPU (Central Processing Unit) and carries out the information process in response to the input of the information sent through the LAN 5. The processor 11 instructs the memory 12 to update the information correspondingly to the executed information process, and the memory 12 updates the stored information in response to the instruction.

The memory 12 is the information storing function block installed in the parts lifetime managing server 1. It is built in the parts lifetime managing server 1 or connected to outside. The memory 12 has a magnetically storing medium or a semiconductor memory or an information storing function similar to them.

The input output unit 13 is the information input output function block installed in the parts lifetime managing server 1. It has a keyboard from which a character input is possible, a voice collector (microphone) from which a voice input is possible, a touch panel installed on a displaying screen, and the functions similar to them. The input output unit 13 is connected to the processor 11, and the information inputted from the input output unit 13 is outputted to the processor 11. Also, the input output unit 13 has a function of giving the predetermined information visually, acoustically and tactually to the user who uses the parts lifetime managing server 1 having an information displaying function installed in the parts lifetime managing server 1. It has the displaying screen, such as CRT and the like, in order to visually indicate the information, has a voice output unit, such as a speaker and the like, in order to acoustically indicate the information, and has a vibration generating function and the like, in order to tactually indicate the information.

The communicating unit 14 is the communication controlling function block installed in the parts lifetime managing server 1. It has a communication interface to carry out the information communication through the LAN 5 installed inside the part managing facility. The communicating unit 14 outputs the information to be communicated by using a wireless or wired communication, from the communication interface. Also, the communicating unit 14 receives the information sent through the network, from the communication interface.

The parts server 2 is the information processing terminal for storing the information of all designed parts and the information as to whether or not the part is sold as the repair part. It is connected to the LAN 5 installed inside the part managing facility, and it carries out the information communication with the parts lifetime managing server 1 and the terminal 3 through the LAN 5. The parts server 2 further has a processor 21, a memory 22, an input output unit 23 for inputting and outputting the information, and a communicating unit 24 for controlling the information communication that is carried out through the LAN 5.

The processor 21 is the operation processing function block similar to the operation processing function block installed in the parts lifetime managing server 1. The processor 21 installed in the parts server 2 has a CPU (Central Processing Unit) and carries out the information process in response to the input of the information sent through the LAN 5. The processor 21 instructs the memory 22 to update the information correspondingly to the executed information process, and the memory 22 updates the stored information in response to the instruction.

The memory 22 is the information storing function block similar to the information storing function block installed in the parts lifetime managing server 1. The memory 22 installed in the parts server 2 is built in the parts server 2 or connected to outside. The memory 22 has a magnetically storing medium or a semiconductor memory or an information storing function similar to them.

The input output unit 23 is the information input output function block similar to the information input output function block installed in the parts lifetime managing server 1. The information input output function block installed in the parts server 2 has a keyboard from which a character input is possible, a voice collector (microphone) from which a voice input is possible, a touch panel installed on a displaying screen, and the functions similar to them. The input output unit 23 is connected to the processor 21, and the information inputted from the input output unit 23 is outputted to the processor 21. Also, the input output unit 23 has a function of giving the predetermined information visually, acoustically and tactually to the user who uses the parts server 2 having the information displaying function installed in the parts server 2. It has the displaying screen, such as CRT and the like, in order to visually indicate the information, has a voice output unit, such as a speaker and the like, in order to acoustically indicate the information, and has a vibration generating function and the like, in order to tactually indicate the information.

The communicating unit 24 is the communication controlling function block similar to the communication controlling function block installed in the parts lifetime managing server 1. The communication controlling function block installed in the parts server 2 has a communication interface to carry out the information communication through the LAN 5 installed inside the part managing facility. The communicating unit 24 outputs the information to be communicated by using a wireless or wired communication, from the communication interface. Also, the communicating unit 24 receives the information sent through the LAN 5, from the communication interface.

The terminal 3 is the information processing terminal that can carry out the information communication with the parts lifetime managing server 1 and the parts server 2. It is connected to the LAN 5 installed inside the part managing facility, and carries out the information communication with the predetermined servers and the other terminals 3 through the LAN 5. The terminals 3 are placed at any points inside the part managing facility and sends the information, which are written to the parts lifetime managing server 1 and the parts server 2, through the LAN 5 to the respective servers. Also, the terminal 3 receives the information, which is sent from the parts lifetime managing server 1, the parts server 2 or the other terminals 3 connected to the LAN 5, through the LAN 5. The terminal 3 further includes a processor 31, a memory 32, an input output unit 33 for inputting and outputting the information, and a communicating unit 34 for controlling the information communication which is carried out through the LAN 5.

The processor 31 is the operation processing function block installed in the terminal 3. It has a CPU (Central Processing Unit) and carries out the information process in response to the input of the information sent through its network. The processor 31 instructs the memory 32 to update the information correspondingly to the executed information process, and the memory 32 updates the stored information in response to the instruction.

The memory 32 is the information storing function block installed in the terminal 3. It is built in the terminal 3 or connected to outside, and has a magnetically storing medium or a semiconductor memory or an information storing function similar to them. The memory 32 updates the stored information, correspondingly to the instruction from the processor 31. The communicating unit 34 is the communication controlling function block installed in the terminal 3. It has a communication interface to carry out the information communication through the network installed inside the facility.

The input output unit 33 is the information input output function block installed in the terminal 3. It has a keyboard from which a character input is possible, a voice collector (microphone) from which a voice input is possible, a touch panel installed on a displaying screen, and the functions similar to them. The input output unit 33 is connected to the processor 31, and the information inputted from the input output unit 33 is outputted to the processor 31. Also, the input output unit 33 has an information displaying function installed in the terminal 3. It has a function of giving the predetermined information visually, acoustically and tactually to the facility user who uses the terminal 3. It has the displaying screen, such as CRT and the like, in order to visually indicate the information, has a voice output unit, such as a speaker and the like, in order to acoustically indicate the information, and has a vibration generating function and the like, in order to tactually indicate the information. The communicating unit 34 outputs the information to be communicated by using a wireless or wired communication, from its communication interface. Also, the communicating unit 34 receives the information sent through the network, from the communication interface.

The external terminal 4 is the external information processing terminal that can carry out the information communication with the predetermined information processing terminals installed in the part managing facility. It is connected to the wide area network 6, and carries out the information communication with the predetermined servers and any terminals 3 through the wide area network 6. The external terminals 4 are installed at any points, such as the selling points and the distributing points, which treat the parts to be sold. They are connected through the LAN 5 to the parts lifetime managing server 1 and the parts server 2, and send and receive the information to and from the respective servers. The external terminal 4 further includes a processor 41, a memory 42, an input output unit 43 for inputting and outputting the information, and a communicating unit 44 for controlling the information communication which is carried out through the wide area network 6.

The processor 41 is the operation processing function block installed in the external terminal 4. It has a CPU (Central Processing Unit) and carries out the information process in response to the input of the information sent through its network. The processor 41 instructs the memory 42 to update the information correspondingly to the executed information process, and the memory 42 updates the stored information in response to the instruction.

The memory 42 is the information storing function block installed in the external terminal 4. It is built in the external terminal 4 or connected to outside, and has a magnetically storing medium or a semiconductor memory or an information storing function similar to them. The memory 42 updates the stored information, correspondingly to the instruction from the processor 41. The communicating unit 44 is the communication controlling function block installed in the external terminal 4. It has a communication interface to carry out the information communication through the network installed inside the facility.

The input output unit 43 is the information input output function block installed in the external terminal 4. It has a keyboard from which a character input is possible, a voice collector (microphone) from which a voice input is possible, a touch panel installed on a displaying screen, and the functions similar to them. The input output unit 43 is connected to the processor 41, and the information inputted from the input output unit 43 is outputted to the processor 41. Also, the input output unit 43 has an information displaying function installed in the external terminal 4. It has a function of giving the predetermined information visually, acoustically and tactually to the facility user who uses the external terminal 4. It has the displaying screen, such as CRT and the like, in order to visually indicate the information, has a voice output unit, such as a speaker and the like, in order to acoustically indicate the information, and has a vibration generating function and the like, in order to tactually indicate the information. The communicating unit 44 outputs the information to be communicated by using a wireless or wired communication, from its communication interface. Also, the communicating unit 44 receives the information sent through the network, from the communication interface.

The LAN 5 is the information communication network installed in the part managing facility. It is connected to the parts lifetime managing server 1, the parts server 2 and the terminal 3, and sends the information outputted from their information processing terminals, via the wired or wireless communication to a predetermined output destination. Also, it is connected to the wide area network 6, and specifies the external terminal 4 from the predetermined information processing terminal, and then sends the output information through the wide area network 6 to the external terminal 4.

The wide area network 6 is the information communication network represented by the Internet. Itis connected to a plurality of external terminals, and the plurality of external terminals are connected through the wide area network 6 to the LAN 5.

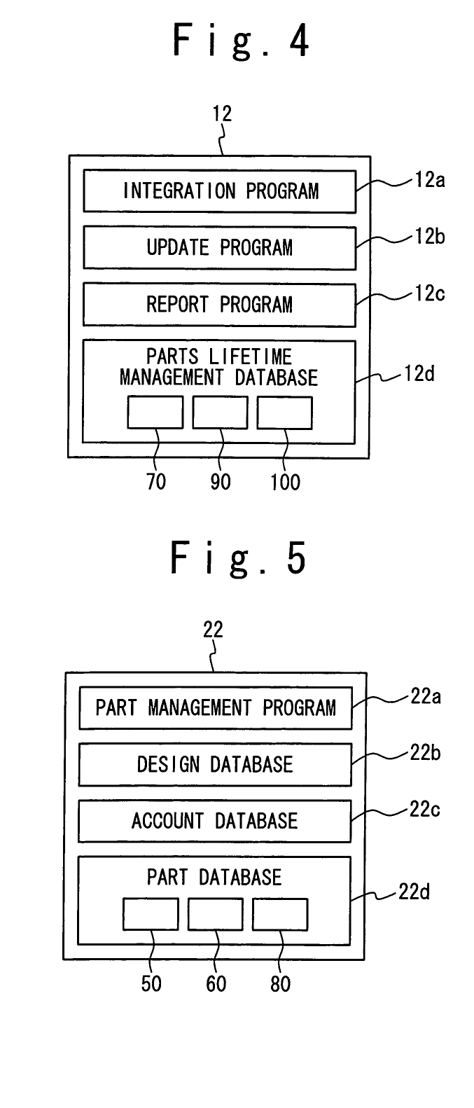

With reference to FIG. 4, it shows the configuration of the data stored in the memory 12. The memory 12 stores: an integration program 12a serving as a program which is read out and executed by the processor 11; an update program 12b; and a report program 12c. The memory 12 further stores a parts lifetime management database 12d which registers data so that the processor can carry out the retrieving, reading and writing operations. The parts lifetime management database 12d stores a table 70, a table 90 and a table 100.

With reference to FIG. 5, it shows the configuration of the data stored in the memory 22. The memory 22 stores a part managing program 22a serving as a program which is read out and executed by the processor 21. The memory 22 further stores: a design database 22b which registers data so that the processor 21 can carry out the retrieving, reading and writing operations; an account database 22c; and a part database 22d. The part database 22d stores a table 50, a table 60 and a table 80.

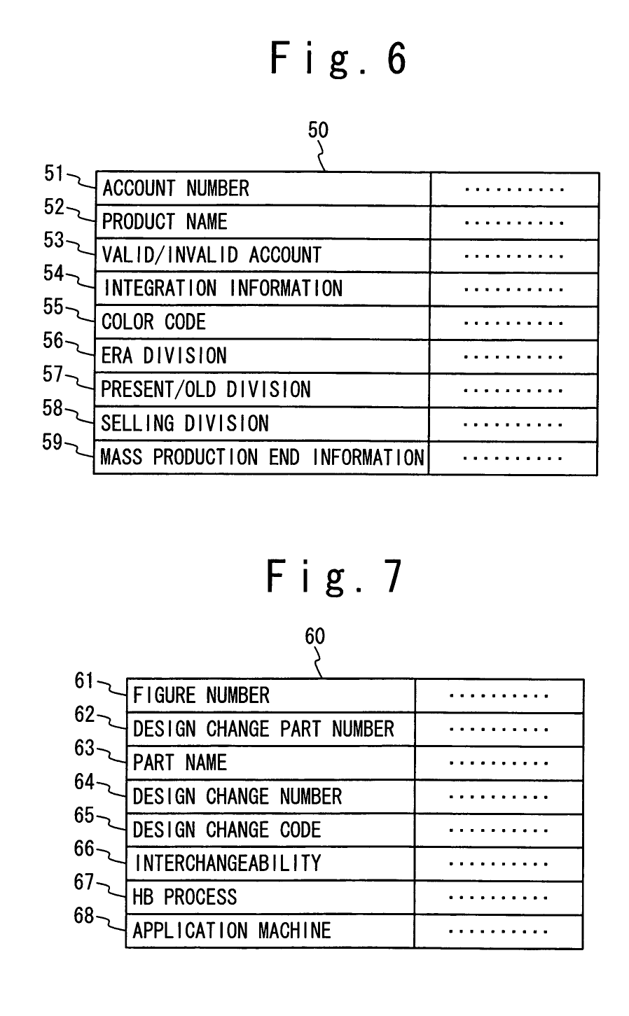

With reference to FIG. 6, it shows the configuration of the table 50. An account number 51 is stored in each of the plurality of records stored in the table 50. The table 50 further stores, as the content of the account (selling account) corresponding to the account number 51, a product name 52, a valid/invalid account 53, an integration information 54, a color code 55, an era division 56, a present/old division 57, a selling division 58 and a mass production end information 59, while they are correlated to each other.

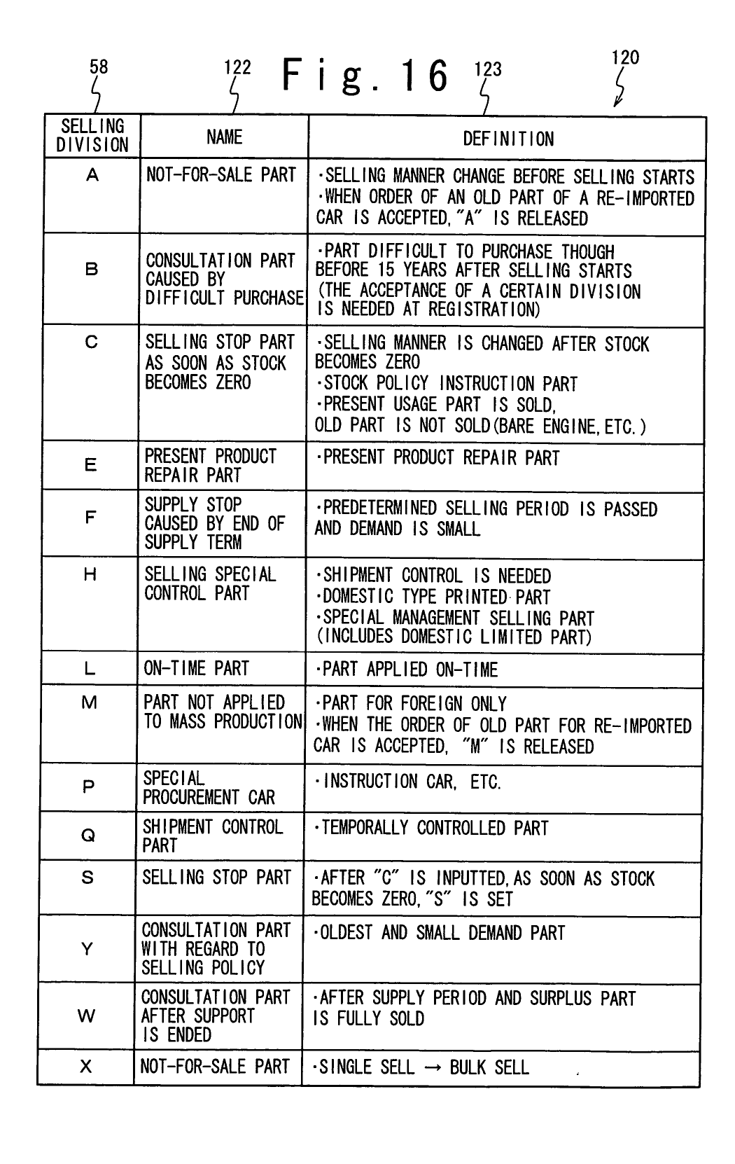

With reference to FIG. 16, it shows a selling division table 120. Preferably, the selling division table 120 can be stored in the parts server 2 and referred by the external terminal 4. The selling division table 120 shows the selling division 58, a name 122 and a definition 123, while they are correlated to each other.

[Not-for-sale part] whose selling division 58 is A indicates the product which was not sold because of the change in the selling manner before the start of the selling of the product to which the part was applied. As for the not-for-sale part 122, when the old type part of a reverse import car is ordered, the A of the selling division 58 is released, and the selling is executed.

[Consultation part caused by difficult purchase] whose selling division 58 is B indicates the part which is 15 years or less after the mass production end and difficult to purchase. The admission of a predetermined department is required to set the B for the selling division 58.

[Selling stop part as soon as stock becomes zero] whose selling division 58 is C indicates: the part which is planned such that the selling manner is changed when the parts presently being stocked are all shipped; the part in which the instruction of a predetermined measure is applied to the stock; or the part which is not sold with regard to the product of the old type although sold when the product is presently used (for example: a bare engine).

[Present product repair part] whose selling division 58 is E indicates the part which is used for the repair correspondence to the present product.

[Supply stop caused by end of supply term] whose selling division 58 is E indicates the part where the predetermined number of years elapses after the product to which the part is applied becomes the old type and where the demand in the whole world is equal to or less than a predetermined standard.

[Selling special management part] whose selling division 58 is H indicates the part in which it is admitted that a certain limit needs to be imposed on a shipment, or the part in which a domestic model is graven, or the part on which the special management with regard to the selling (including the limit on the domestic sales territory) is imposed.

[On-time part] whose selling division 58 is L indicates the part in which the on-time is applied to the supply of the part.

[Part that is not applied to mass production] whose selling division 58 is M indicates the part which is dedicated to foreign countries and whose selling in Japan is not admitted. If there is the order as the old type part of the reverse import car, the M of the selling division 58 is released.

[Special procurement car] whose selling division 58 is P indicates the special vehicle such as a training car and the like.

[Shipment control part] whose selling division 58 is Q indicates the part whose shipment is transiently limited.

[Selling stop part] whose selling division 58 is S indicates the part in which the stock, order and warehousing stock becomes zero in the [selling stop part as soon as stock becomes zero] where the selling division 58 is set for the C. The parts lifetime managing server 1 automatically changes the selling division 58 of the table 50 to the S, when the stock, order and warehousing stock of the part whose selling division 58 is the C becomes zero.

[Consultation part with regard to selling policy] whose selling division 58 is Y indicates the part where the product to which the part is applied is the oldest type and where the demand in a predetermined period is equal to or less than a predetermined number.

[Consultation part after support is ended because of manufacture stop] whose selling division 58 is W indicates the part where the part to which the part is applied exceeds the term of the manufacture and where the support until the supply year is already ended, or the part where the support is unnecessary.

[Not-for-sale part (part corresponding to bulk)] whose selling division 58 is X indicates that the part sold as the single unit is changed to the selling manner as a bulk because of the stop of the selling manner as the single unit.

The above-mentioned selling divisions are further divided into the domestic usage and the foreign usage, coded and stored in the table 50.

With reference to FIG. 7, it shows the configuration of the table 60. The table 60 stores a figure number 61, a design change number (design change part number) 62, a part name 63, a design change number 64, a design change schematic code 65, an interchangeability (or a compatibility) 66, an HB process 67 and an application machine 68, while they are correlated to each other.

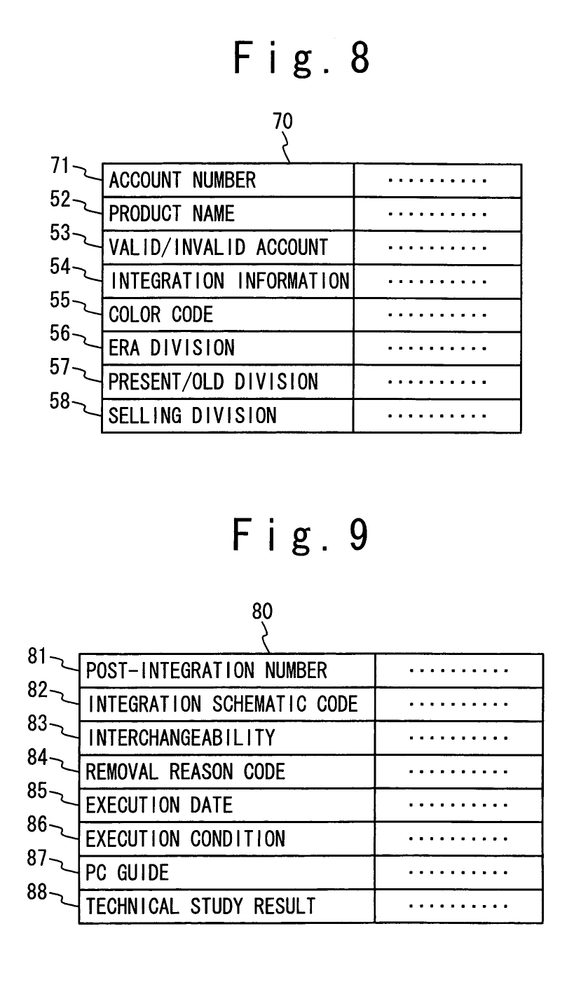

With reference to FIG. 8, it shows the configuration table 70. The table 70 stores an account number 71, the product name 52, the valid/invalid account 53, the integration information 54, the color code 55, the era division 56, the present/old division 57 and the selling division 58, while they are correlated to each other.

With reference to FIG. 9, it shows the configuration of the table 80. The table 80 stores an post-integration number 81, an integration schematic code 82, an interchangeability 83, a removal reason code 84, an execution date 85, an execution condition 86, a PC guide necessary/unnecessary item 87 and a technical study result 88, while they are correlated to each other.

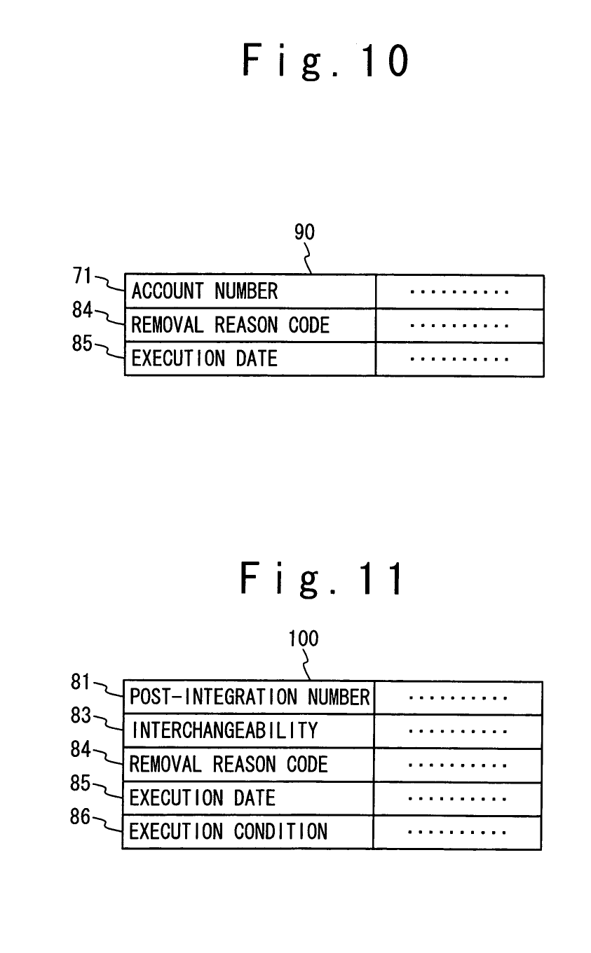

With reference to FIG. 10, it shows the configuration of the table 90. The table 90 stores the account number 71, the removal reason code 84 and the execution date 85, while they are correlated to each other.

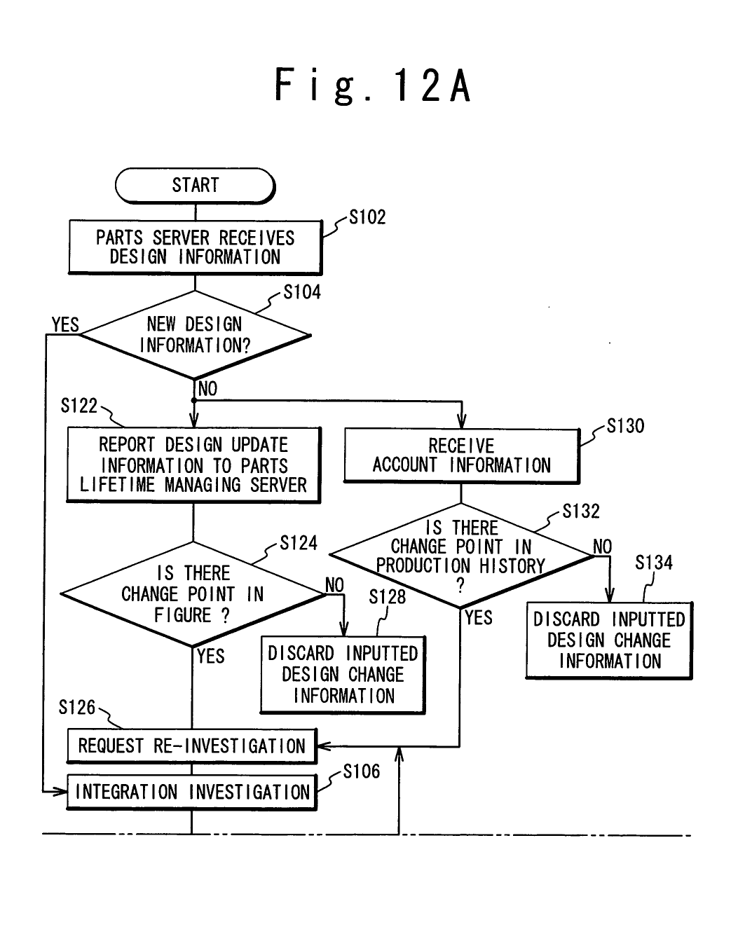

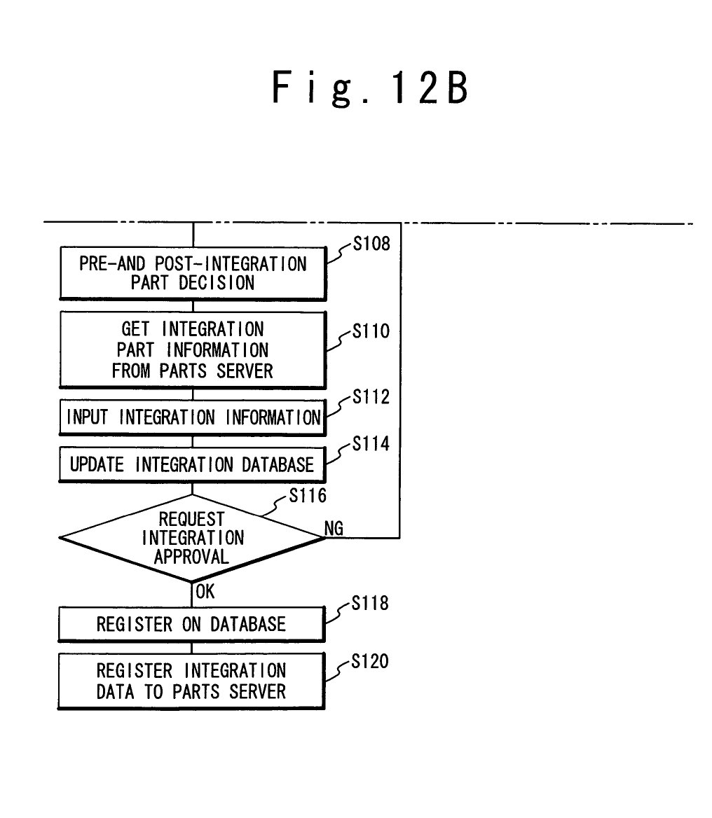

With reference to FIG. 11, it shows the configuration of the table 100. The table 100 stores the post-integration number 81, the interchangeability 83, the removal reason code 84, the execution date 85 and the execution condition 86, while they are correlated to each other.

(Operation of Execution)

The operations in the best mode for carrying out the invention will be described below with reference to the drawings.

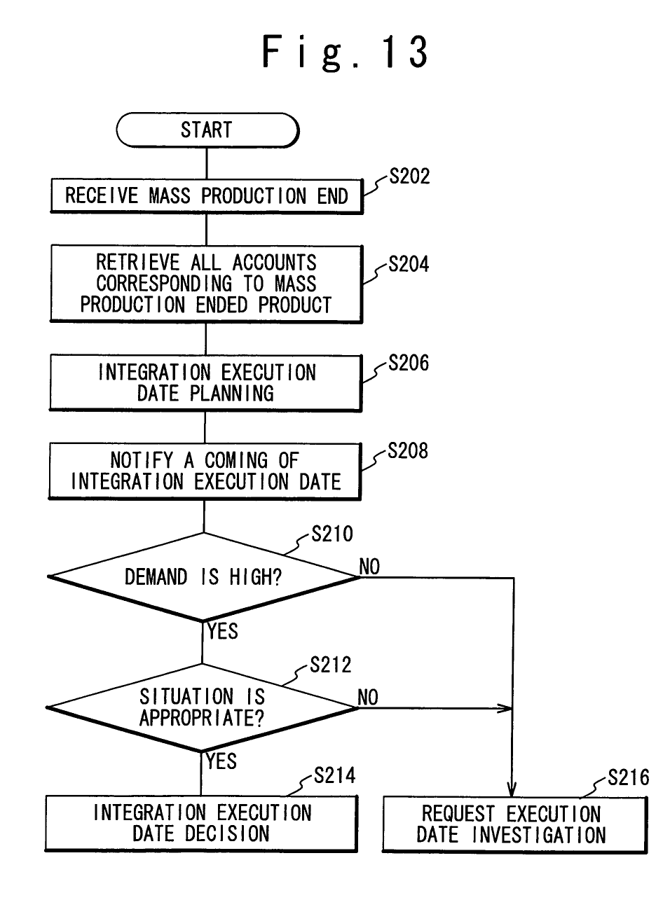

FIG. 12 is a flowchart showing the integration timing or selling stop timing setting operation in the part lifetime managing system 49 of the present invention. With reference to FIG. 12, the integration timing or selling stop timing setting operation is started when the part is designed and the designer outputs the design information.

At a step S102, the parts server 2 receives the design information which the designer outputs, in response to the design completion. The design information includes all of the information with regard to a plurality of parts whose designs were completed. In particular, it includes the identification information indicating whether the part is the newly designed part or the part after the design change of the existing part. Also, the design information includes: the drawing number 61 used when the part after the design completion is outputted as the drawing; the design change part number 62 indicating the part whose design is changed; the part name 63 indicating the name of the part; the design change number 64 in which the information of the design change is coded when the design is changed; the design change schematic code 65 in which the schematic information of the design change is coded; the interchangeability 66 between the respective parts before the design change and after the design change; and the like. The parts server 2 updates the design database 22b on the basis of the received design information.

At a step S104, the parts server 2 judges whether the received design information is the information with regard to a new part or the information with regard to the design change of the existing part. As the result of the judgment, in the case of the design information with regard to the newly designed part, the parts server 2 outputs an integration consideration instruction on the basis of the received design information, and the process proceeds to a step S106. Also, as the result of the judgment, if the received design information is related to the design change of the existing part, the process proceeds to a step S122 and a step S130.

At a step S106, the integration consideration or the selling stop consideration is carried out in accordance with the output consideration instruction. The considering work is started approximately simultaneously with the completion of the part design. As for the occurrence of the doubtful points with regard to the specification on the design and the like, for each occurrence, the query is performed on the designer. Then, the integration consideration or the selling stop consideration is carried out on the basis of the answer to the query.

At a step S108, as the result of the integration consideration, if there is the set that can be integrated, the consideration with regard to the post-integration is carried out, and the pre-integration and the post-integration are determined on the basis of the consideration result.

At a step S110, the part number indicating the determined pre-integration and post-integration is inputted to the parts server 2. The parts server 2 retrieves the account database 22c with the input part number as a key, and confirms whether or not there is the selling account in which the part is used as the member. As the retrieved result, if there is the corresponding selling account, the parts server 2 outputs the information of the selling account to the parts lifetime managing server 1.

Preferably, the integration information is inputted to the integration database in the short period after the design of the part, for example, between several dates and several weeks, or before the shipment of the product using the part. In the short period after the design of the part, the detailed information with regard to the part is easily obtained from the designer or maker. For this reason, it is easy to consider whether or not the parts can be integrated. For this reason, the integration of the parts which will be carried out in future is set in the short period. This results in the drop in the cost to manage the parts for a long period. Moreover, it is easy to insure the high quality with regard to the part after the integration.

At a step S112, the parts lifetime managing server 1 receiving the output account information requires the input of the information indicated in the respective items of the table 50. The information, which are inputted in response to the request and indicated in the respective items of the table 50, are outputted to the parts lifetime management database 12d after the completion of the input. Also, the parts lifetime managing server 1 correlates the removal reason code 74 and the reason corresponding to the removal reason code 74 to each other, and outputs to the parts lifetime management database 12d, in order to quickly and suitably cope with the query done by a client after the execution of the integration, with regard to the integration which will be planned in future.

At a step S114, the parts lifetime management database 12d receiving the output integration information updates the table 80 stored in the parts lifetime management database 12d, transiently, namely, so as to enable the return to the original state by using a predetermined operation. The parts lifetime managing server 1 completing the transient update of the table 80 generates the integration admission request in response to the update completion. The generated integration admission request is sent through the LAN 5 to the predetermined terminal 3.

At a step S116, each of the terminals receiving the sent integration admission request displays an answer input screen with regard to the admission of the integration in response to the integration admission request. The input answer is reported through the LAN 5 to the parts lifetime managing server 1. If the input answer has the answer of an integration rejection, a review request is outputted (Step S126), and the review with regard to the integration is performed.

At a step S118, if the answer with regard to the admission of the integration does not have the answer indicating the rejection, the content of the transiently updated table 80 is treated as the normal information, and the regular registration is performed.

At a step S120, the parts lifetime managing server 1 sends the registration completion report and the content of the table 80 to the parts server 2, in response to the completion of the regular registration.

Due to this operation, in the case of managing the repair parts used to repair the product supplied to the market, it is possible to plan the future part management schedule at the time of the part design, and it is possible to largely reduce the labor for the management of the repair parts.

If the design change occurs, after the judgment at the step S104, the process proceeds to a step S122 and a step S130.

At the step S122, the parts server 2 updates the design database 22b in response to the received design change information, and outputs the design change information stored in the table 60 to the parts lifetime managing server 1, in response to the update completion.

At a step S124, the parts lifetime managing server 1 retrieves the parts lifetime management database 12d, as to whether or not the information with regard to the integration of the corresponding parts is stored, in accordance with the design change part number 62 included in the received design change information and the like. As the result of the retrieval, if the information of the integration with regard to the part before the corresponding design change is stored, whether or not there is a change point having an influence on the integration is judged. As the result of the judgment, if there is the change point having the influence on the integration, the review request is outputted through the network to the predetermined terminal (Step S126). Also, if there is not the change point having the influence on the integration, the parts lifetime managing server 1 discards the design change integration sent from the parts server 2 (Step S128).

Also, at the step S130, the parts server 2 updates the design database 22b correspondingly to the received design change information, and outputs the design change information to the parts lifetime managing server 1 in response to the update completion and also updates the account database 22c correspondingly to the received design change information. The parts server 2 outputs the information of the selling account containing the design-changed part as the configuration part to the parts lifetime managing server 1, in response to the update completion of the account database 22c.

At a step S132, the parts lifetime managing server 1 retrieves the parts lifetime management database 12d, as to whether or not the information with regard to the integration of the corresponding accounts is stored, in accordance with the design change part number 62 included in the received design change information and the like. As the result of the retrieval, if the information of the integration with regard to the account before the corresponding design change is stored, whether or not there is the change point having the influence on the integration is judged. As the result of the judgment, if there is the change point having the influence on the integration, the review request is outputted through the network to the predetermined terminal (Step S126). Also, if there is not the change point having the influence on the integration, the parts lifetime managing server 1 discards the design change integration sent from the parts server 2 (Step S128).

Due to this operation, with regard to the management schedule of the repair parts planned at the time of the part design, even if the occurrence of the factor that must be changed when the repair parts are supplied to the market, it is possible to change the repair part supply timing correspondingly to the various occurring factors. Also, as the result of the selling stop consideration, as for the part where the future integration will not be done since the product on the market can be used instead and where the selling will be planned to be stopped, it is possible to attain by changing the integration in the above-mentioned flowchart to the selling stop.

FIG. 13 is a flowchart showing the operation for determining the integration execution date in the part lifetime managing system 49 of the present invention. With reference to FIG. 13, the operation for determining the integration execution date is started when the mass production end date of the product is determined.

At a step S202, the parts server 2 receives the mass production end information including the information of the date when the mass production of the product is ended and the like, through the LAN 5. The parts server 2 receiving the mass production end information reports the information of the mass production end date included in the mass production end information and the like, to the parts lifetime managing server 1.

At a step S204, the parts lifetime managing server 1 extracts the accounts of the repair parts corresponding to the product whose mass production is determined to be ended and the execution timing 85 which is the information indicating the integration execution timing established by defining a certain period after the mass production end date correspondingly to each of the accounts, from the parts lifetime management database 12d, in accordance with the reported information.

At a step S206, as for the respective extracted accounts, the integration execution date is calculated on the basis of the mass production end date reported from the parts server 2, and the calculated integration execution date is defined as an integration execution plan date, and it is transiently stored in the memory.

At a step S208, the parts lifetime managing server 1 generates an integration execution report message including the calculated integration execution plan date, and then sends the integration execution report message through the network to the predetermined terminal.

At a step S210, the terminal receiving the integration execution report message automatically outputs an integration consideration request screen. The terminal requires the input of the answer as to whether or not there are many demands in the market with regard to the account of the integration execution plan, on the integration consideration request screen. If the input answer in response to the request is a zero demand or a very little demand, the process proceeds to a step S216. If the input answer in response to the request is a demand existence, the process proceeds to a step S212.

At the step S212, the terminal requires the input of the answer as to whether or not with regard to the account of the integration execution plan on the integration consideration request screen, it is the situation suitable for the integration execution, such as the situation of the law regulation, the change in fashion and the like. In the case of the input of the negative answer implying that the input answer in response to the request is not suitable, the process proceeds to the step S216. In the case of the positive answer implying that the input answer in response to the request is suitable for the integration execution, the terminal prepares the integration admission message, and then sends the integration admission message through the LAN 5 to the parts lifetime managing server 1.

At a step S214, the parts lifetime managing server 1 receiving the integration admission message determines the transiently stored integration execution plan date as the integration execution date, and then registers in the parts lifetime management database 12d.

At the step S216, the parts lifetime managing server 1, which receives the answer that the demand in the market is zero or very little or the integration rejection message including the answer that it is not the situation suitable for the integration execution, outputs an integration execution date consideration request through the LAN 5 to the predetermined terminal 3.

Due to this operation, with regard to the management schedule of the repair parts planned at the time of the part design, even if the factor that must be changed is induced when the repair parts are supplied to the market, it is possible to change the repair part supply timing correspondingly to the various induced factors. In particular, even if the design change is performed on the repair part which will be planned to be supplied in future, the management schedule of the repair part can be changed following the design change.

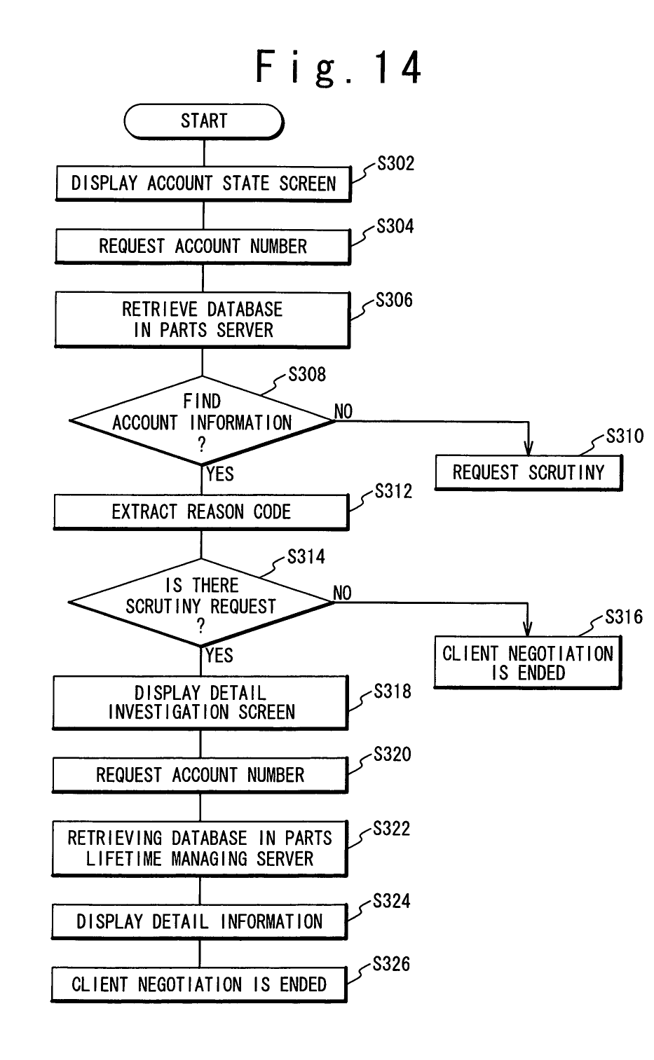

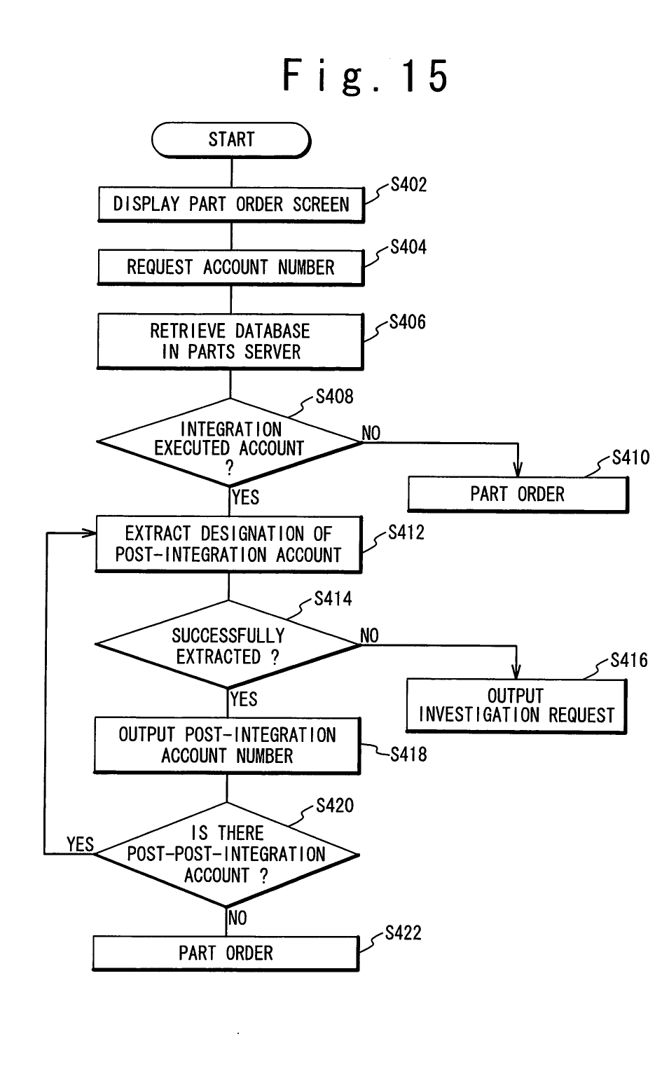

FIG. 14 is a flowchart showing the operation when a dealer, such as a selling service shop or the like, who receives a query from a client with regard to an integrated account, copes with the query, in the part lifetime managing system 49 of the present invention. With reference to FIG. 14, a client negotiation operation is started when the dealer receives the query from the client with regard to the integrated account.

At a step S302, the operator working in the selling service shop or the like actuates the external terminal 4 installed in the selling service shop and displays an account state confirmation screen, when there is the query from the client with regard to the integrated account. At a step S304, the external terminal 4 requires the input of an account number inquired on the account state confirmation screen. The external terminal 4 prepares an account state confirmation message including the input account number, and sends the account state confirmation message through the wide area network 6 to the parts server 2.

At a step S306, the parts server 2 receiving the account state confirmation message retrieves the part database 22d on the basis of the account number included in the message.

At a step S308, if the information shown in the table 80 which corresponds to the account number sent from the external terminal cannot be detected as the retrieved result, the parts server 2 prepares an account examination request and outputs the account examination request through the network to a predetermined terminal (Step S310). If the information shown in the table 80 which corresponds to the account number sent from the external terminal 4 is detected, the process proceeds to a step S312.

At the step S312, the parts server 2 sends the detected information shown in the table 80, through the wide area network to the external terminal. The external terminal updates the account state confirmation screen in response to the reception of the sent information shown in the table 80, and extracts the removal reason code 84 correspondingly to the update of the screen. The external terminal 4 displays a client negotiation manual corresponding to the extraction of the removal reason code 84 on the screen, and carries out the client negotiation.

At a step S314, whether or not there is the further detailed examination request is judged. As the judged result, if there is not the detailed examination request, the process proceeds to a step S316, and the client negotiation is ended. If there is the detailed examination request, a predetermined operation is performed to thereby display an account detail examination screen on the external terminal 4 (Step S318).

At a step S320, the external terminal 4 requires the input of the account number inquired on the account detail examination screen. The external terminal 4 prepares the account detail examination message including the input account number, and sends the account detail examination message through the wide area network 6 to the parts server 2.

At a step S322, the parts server 2 responds to the reception of the account detail examination message, and requires the parts lifetime managing server 1 to retrieve the data in the parts lifetime management database 12d. The retrieval is carried out by using the account number included in the account detail examination message as a key. The parts lifetime managing server 1 outputs all of the information indicated by the table 80, which correspond to the account number sent from the external terminal 4, correspondingly to the retrieval request, and reports the output information to the parts server 2. The parts server 2 prepares a detail report message including the reported information, and sends the detail report message through the wide area network 6 to the external terminal 4.

At a step S324, the external terminal updates the account detail examination screen in accordance with the sent detail report message, and displays the detail information. On the basis of the displayed detail information, the detail explanation is carried out to then carry out the client negotiation (Step S326).

Consequently, although the execution was conventionally difficult, the initial answer to the query from the client can be easily executed.

Also, even if the further detailed explanation is required for the schematic explanation, the quick correspondence becomes possible, which enables the increase in the client satisfaction.

FIG. 15 is a flowchart showing the operation when an order is performed on the integrated account, in the part lifetime managing system 49 of the present invention. With reference to FIG. 15, the ordering operation is started at the time of the reception of the order from the client to the integrated account.

At a step S402, the operator working in the selling service shop or the like actuates the external terminal 4 installed in the selling service shop, and displays a part order screen, if there is the order from the client to the integrated account. At a step S404, the external terminal 4 requires the input of the account number of the ordered repair part on the part order screen. The external terminal 4 prepares the order message including the input account number, and then sends the order message through the wide area network 6 to the parts server 2.

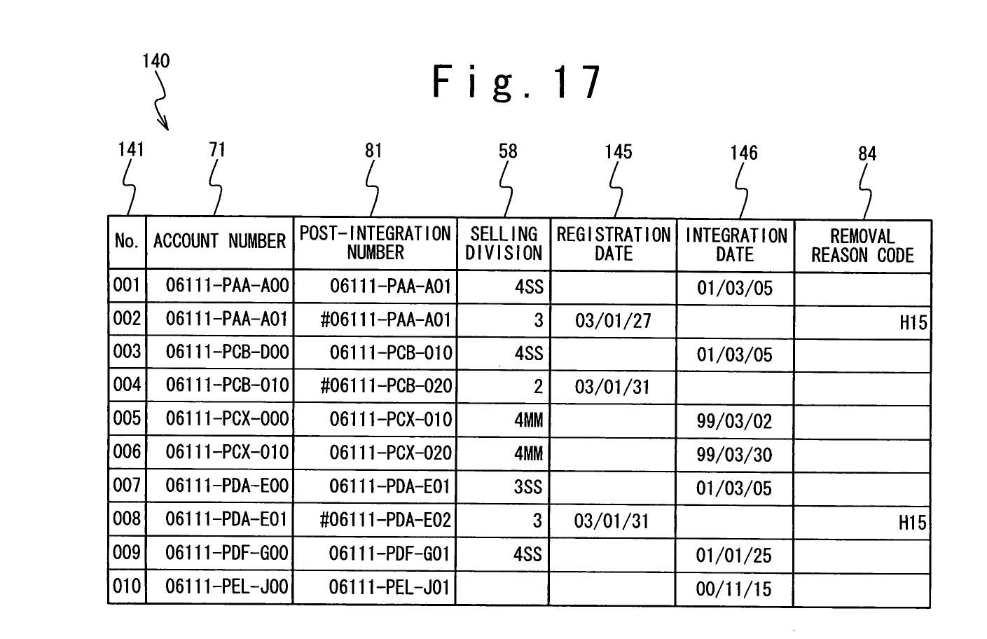

With reference to FIG. 17, it shows a terminal screen 140 displayed on a displaying unit of the input output unit 43 when the external terminal 4 accesses the parts server 2. The terminal screen 140 displays a number 141, the account number 71, the post-integration number 81, the selling division 58, a registration date 145, an integration date 146 and the removal reason code 84, while they are correlated to each other. The operator carries out the client negotiation while referring to the newest information with regard to the integration of the parts and the selling division from the terminal screen 140.

At a step S406, the parts server 2 receiving the order message retrieves the part database 22d in accordance with the account number included in the message.

At a step S408, when the parts server 2 cannot detect the information of the account corresponding to the account number sent from the external terminal 4 as the retrieved result, the parts server 2 prepares an account examination request, and outputs the account examination request through the LAN 5 to a predetermined terminal (similar to the step S310). If detecting the information of the account corresponding to the account number sent from the external terminal 4, the parts server 2 judges whether or not the account is an already-integrated account. If the account is not the already-integrated account, the process proceeds to a step S410, and the part is ordered. If the account is the already-integrated account, the process proceeds to a step S412, and an extracting process for an post-integration account is instructed.

At a step S414, the parts server 2 judges whether or not the post-integration of the ordered part can be extracted. If the parts server 2 cannot extract the post-integration account, the parts server 2 prepares the account examination request, and outputs the account examination request through the network to the predetermined terminal (Step S416). If the parts server 2 extracts the post-integration account of the ordered part, the process proceeds to a step S418, and the post-integration number 81 to specify the post-integration account is extracted.

At a step S420, it is judged whether or not the further integration account exists in the extracted post-integration account. As the judged result, if there is the further integration account, the flow returns to the step S412. As the judged result, if the further integration account does not exist in the extracted account, the process proceeds to a step S422, and the ordered part is ordered.

Consequently, even if the further specified integration account exists in the account specified as the post-integration, it is possible to provide the proper repair part.

Also, since the post-integration is sequentially extracted, the repair part optimal for the client needs can be provided.

Since such a system is used to manage the repair parts, the integration of the parts (the provision of a certain part is stopped to switch to the other part) and the task to plan the selling stop are simplified. The integration of the parts reduces the labor and cost which are required to manage the parts, for example, the die of the part can be discarded.

[Account Reduction Following]

There may be a case that the part in which the account is established and the plan of a future integration or selling stop is registered in the parts lifetime managing server 1 is not produced or its manufacture is stopped because of any reason. The procedure for following the part integration or selling stop when the part whose future integration or selling stop is planned is selling-stopped will be described below with reference to the drawings.

At the step S130 of the operational flow shown in FIG. 12, the parts server 2 receives the account information including the selling division 58. At the step S132, the parts lifetime managing server 1 receives the account information including the selling division 58 from the parts server 2, and extracts the portion to which the information indicating that the part is not manufactured or the information indicating the stop of the manufacture is added. At the step S126, the parts lifetime managing server 1 prepares the review request in accordance with a predetermined procedure, and displays on a predetermined terminal.

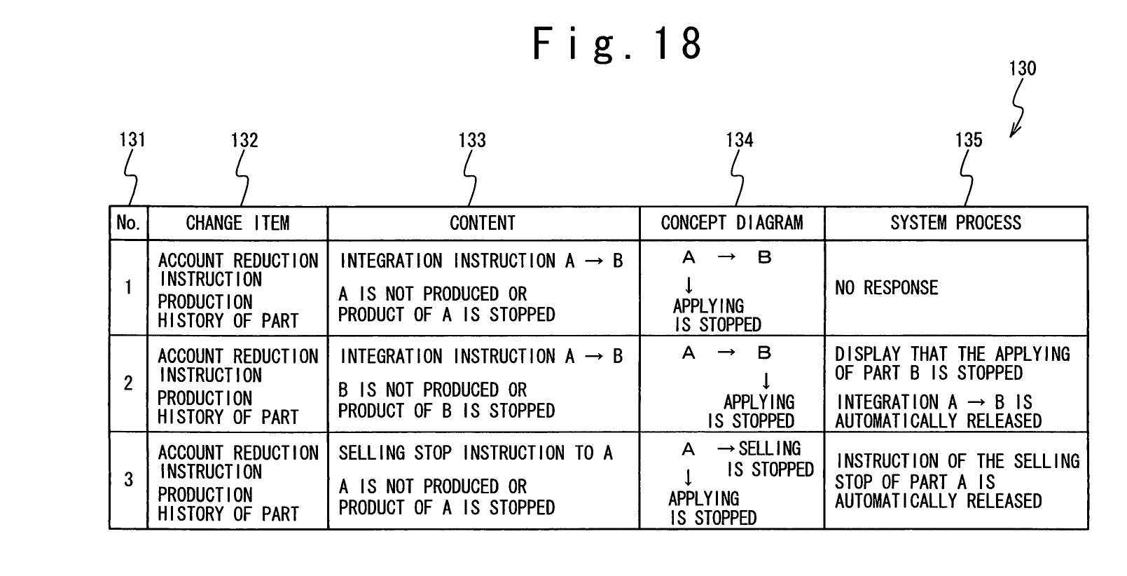

With reference to FIG. 18, it shows a following logic table 130 to explain in detail the following operations that the parts lifetime managing server 1 carries out at the steps 132, 126 when the part is not manufactured or the manufacture is stopped. Correspondingly to the information with regard to the manufacture or selling which is stored in the memory 12 of the parts lifetime managing server 1 and received from the parts server 2, the processor 11 retrieves the following logic table 130. The following logic table 130 stores a priority 131, a change item 132, a content 133, a concept diagram 134 and a system process 135, while they are correlated to each other.

The line in which the priority 131 is 1 indicates the case that a plan of integrating an pre-integration part A into an post-integration part B is registered in the parts lifetime managing server 1 and the pre-integration part A is not manufactured or the manufacture is stopped. In this case, since the account of the pre-integration part A may be integrated into the account of the post-integration part B, the parts lifetime managing server 1 displays on the terminal 3 the fact that the output is not done or there is no necessity of the correspondence.

The line in which the priority 131 is 2 indicates the case that the plan of integrating the pre-integration part A into the post-integration part B is registered in the parts lifetime managing server 1 and the post-integration part B is not manufactured or the manufacture is stopped. In this case, the parts lifetime managing server 1 releases the plan of integrating the pre-integration part A into the post-integration part B. Moreover, it displays on the terminal 3 the fact that the application of the post-integration part B is stopped and the integration is released.

The line in which the priority 131 is 3 indicates the case that a plan of stopping the selling of the part A after a predetermined number of years is registered in the parts lifetime managing server 1 and the part A is not manufactured or the manufacture is stopped. In this case, since there is no need to perform the selling stop on the part A in future, the parts lifetime managing server 1 automatically releases the selling stop plan of the part A, and displays the fact on the terminal 3.

If the two or more conditions indicated when the priority 131 is 1, 2 and 3 are satisfied at the same time, the parts lifetime managing server 1 applies the logic in which the priority 131 is higher (the numeral is smaller).

Due to the above-mentioned operations, the part managing system 49 in this embodiment can quickly change the integration plan, when the manufacture of the part whose integration is planned is stopped because of the reason on the selling.

According to the system for updating the integration information, the integrating plan of the parts is changed at any time in response to the change in the part design, the needs in the market or the maker strategy. Such a part managing system is preferably used to manage the parts in the field in which the support of the repair parts for a long period is desired.

[Selling Manner Change Following]

With regard to the part in which the plan of the future integration or selling stop is registered in the parts lifetime managing server 1, if the selling division 58 satisfies the predetermined condition, the review is desired to be done by the various related departments. The condition will be described below.

At the step 130 of the operational flow shown in FIG. 12, the parts server 2 receives the account information including the selling division 58. At the step S132, the parts lifetime managing server 1 receives the account information including the selling division 58 from the parts server 2. If the received account information exhibits the part where the application plan date of the integration indicated in the execution timing 85 belongs to the predetermined period and where the change is made to the selling division 58, the parts lifetime managing server 1 sends a message of requesting the review of the integration of the part to the terminal 3.

At the step S132, if the received account information exhibits the part where any one selling division 58 of the pre-integration part and the post-integration part is the domestic usage and the other is the foreign usage and where the selling division 58 of the post-integration part is any of A, C, H, M, P, S, F, Q, L, X, B, W, Y or E shown in the selling division table 120, the parts lifetime managing server 1 sends the message of requesting the review of the integration of the part to the terminal 3.

At the step S132, if the received account information exhibits the part where any one selling division 58 of the pre-integration part and the post-integration part is the domestic usage and the other is the foreign usage and where the selling division 58 of the pre-integration part is any of A, C, H, M, P, S, F, Q, L or X shown in the selling division table 120, the parts lifetime managing server 1 sends the message of requesting the review of the integration of the part to the terminal 3. The operator operating the terminal 3 refers to the message and carries out the measure.

At the step S132, in the received account information, if any one selling division of the pre-integration part and the post-integration part is H or P of the domestic usage 58 and the other is the foreign blank (any of A to X is not assigned), the parts lifetime managing server 1 sends the message of requesting the review of the integration of the part to the terminal 3.

At the step S132, if the received account information exhibits the part which was already registered as the pre-integration in any of the parts lifetime management database 12d and the part database 22d and whose selling division 58 was changed, the parts lifetime managing server 1 sends a message indicating the occurrence of an error to the terminal 3.

Through the above-mentioned operations, when the terminal 3 receives the message sent by the parts lifetime managing server 1, the operator operating the terminal 3 refers to the message and carries out the measure.

At the step S162, each of the terminals 3 receiving the sent integration admission request responses to the integration admission request, and displays an answer input screen with regard to the admission of the integration. A responsible person operating the terminal 3, if judging that the integration should be canceled after the confirmation of the reception of an integration target part number, carries out the input operation indicating a rejection from the answer input screen, and the integration plan is canceled. Or, the responsible person circulates the integration plan around the various related departments and requests their opinions, and if judging that the integration should be canceled from the opinions, carries out the input operation indicating the rejection from the answer input screen, and the integration plan is canceled.

From the above-mentioned operations, the part managing system 49 in this embodiment automatically requires the responsible person to carry out the review, if the selling manner may cause the execution of the integration to possibly bring about a trouble. Therefore, it is easy for the responsible person to surely update the integration plan at a proper timing.

[Design Change Following]

The work for following the design change in the case of the occurrence of the design change in the part whose future integration or selling stop is already planned will be described below with referring the drawings.

The part of the machine product exemplified as the car, the two-wheeled vehicle or the general product (the product using the internal-combustion engine, such as the electric generator, the cultivator, the outboard engine, or the like) are often design-changed after provided to the market in many cases. Thus, the part managing system having the updating unit (the changing unit) for updating the integration plan is especially preferably used.

If the part A and the part B exist and the part A is determined to be integrated into the part B in future and if the part A is design-changed to a part A1 before the integration execution, the system cannot automatically set the post-integration of the part A1 to the part B. This reason is as follows. That is, since there are a plurality of manners with regard to the interchangeability between the part before the design change and the part after the design change, it cannot be said that the interchangeability is always established. The manner with regard to the interchangeability usually includes the three manners of: the mutual interchangeability in which the part before the design change and the part after the design change are interchangeable respectively; the higher compatibility in which the part after the design change can be replaced by the part before the design change; and the non-interchangeability in which the part before the design change and the part after the design change do not have any changeability, respectively. Thus, if the part A will be planned to be integrated into the part B in future or if the selling of the part A will be planned to be stopped in future, the following work with regard to the integration/selling stop must be performed on the design change part.

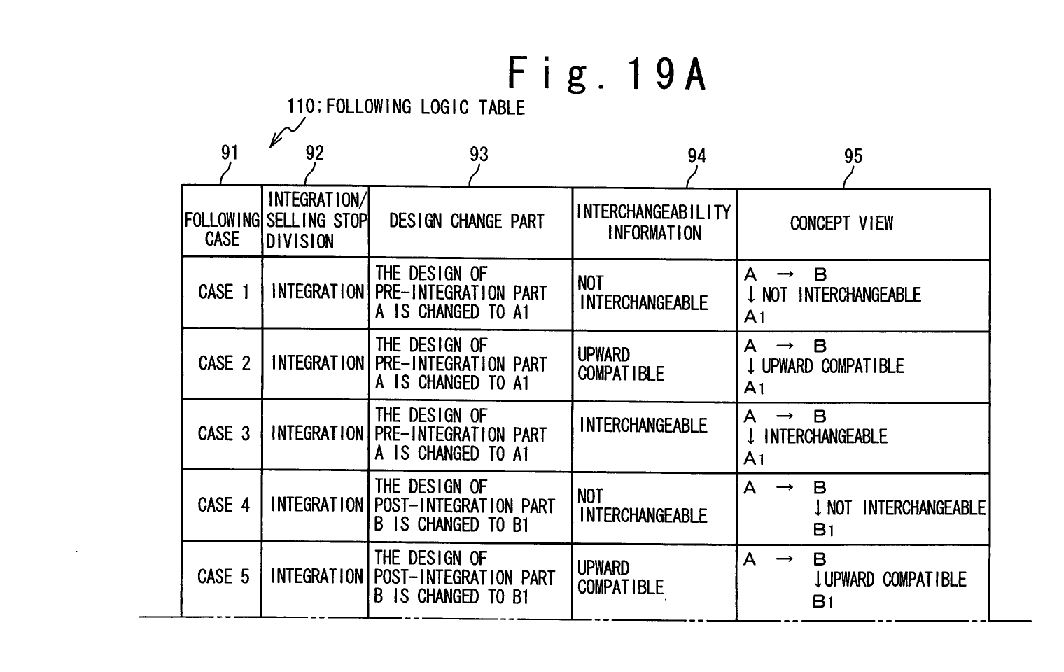

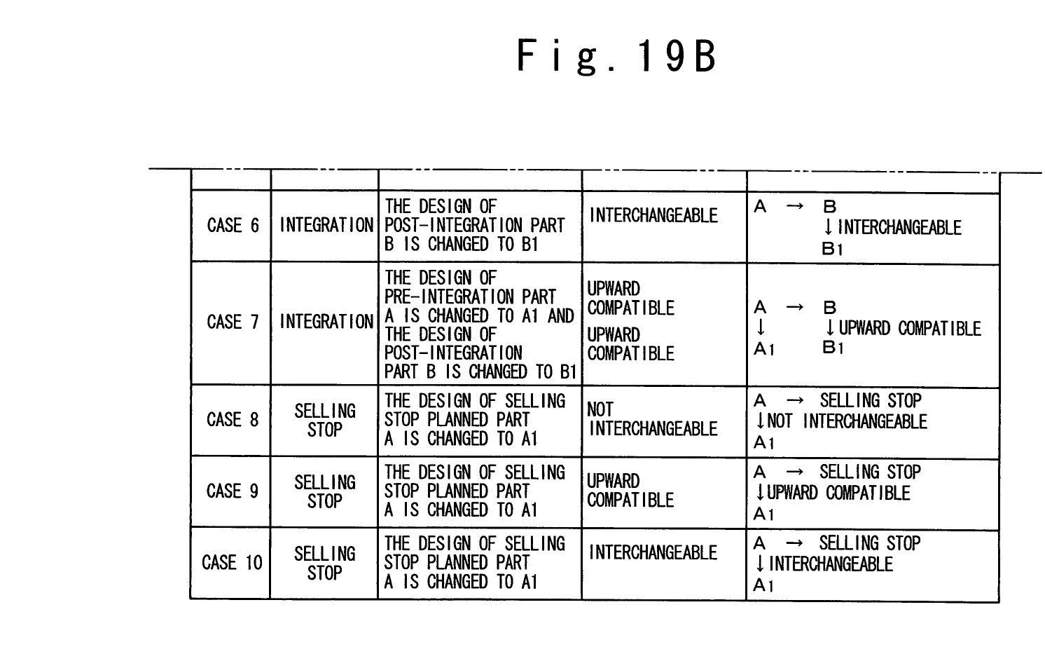

FIG. 19 is a view showing the configuration of a following logic table 110 used to carry out the design change following. It is stored in the memory of the parts lifetime managing server 1, and the information within the table is retrieved in response to the reception of the design change information sent from the parts server 2, and the information for the design change following is provided. With reference to FIG. 19, it shows the configuration of the following logic table 110. A following case 91 indicates a case of a design following corresponding to the design change that usually occurs. An integration/selling stop division 92 indicates the division as to whether each case is the integration or selling stop. A design change part 93 indicates the information to determine the following case based on whether the part related to the design change information sent from the parts server 2 is the pre-integration part (or the selling stop plan part) or the post-integration part. An interchangeability information 94 indicates the interchangeability between the part before the design change and the design change part. A concept view 95 conceptually indicates the design change corresponding to each case. Also, the concept view 95 may be attached to the message, if the report of the design change is sent. Consequently, it is easy to grasp the changing way performed on the responsible person who carries out the review with regard to the integration or selling stop.

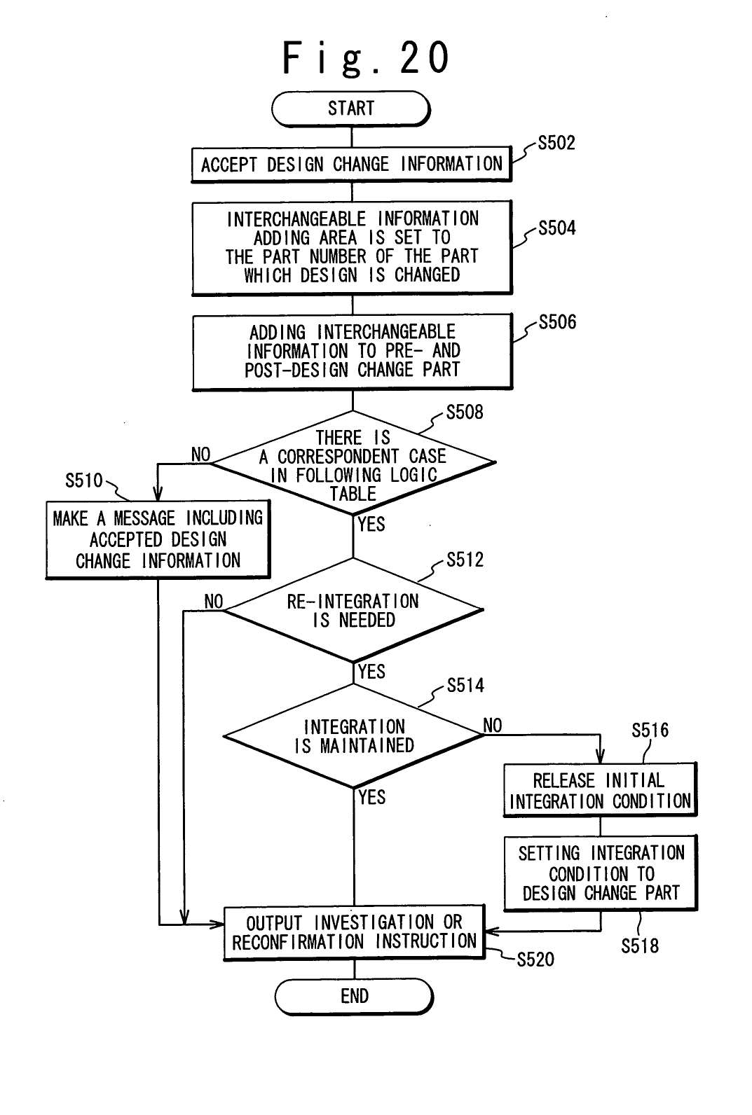

FIG. 20 is a flowchart showing the detail when the design change occurs in the part whose integration or selling stop is planned. FIG. 20 shows in detail the steps from S122 to S126 in the operational flow shown in FIG. 20. With reference to FIG. 20, the operation of the design change following when the design change occurs is started when the parts lifetime managing server 1 receives the design change information sent from the parts server 2. At the step S502, the processor 11 of the parts lifetime managing server 1 judges whether the part before the design change, which corresponds to the design change part, is the pre-integration part (or the selling stop plan part) or the post-integration part, on the basis of the received design change information. If the part before the design change is the pre-integration part (or the selling stop plan part), the processor 11 gives a symbol A to the part, names it a part A, defines the design change part of the part A as a part A1, and advances the process. Also, if the part before the design change is the post-integration part, it gives a symbol B to the part, names it a part B, defines the design change part as a part B1, and advances the process.

At a step S504, the processor 11 establishes the region to assign the compatibility information to the part number of the part corresponding to the design change part included in each table stored in the memory 12. At a step S506, the processor 11 assigns the compatibility between the part before the design change and the part after the design change as the compatibility information to the corresponding part number, in accordance with the design change information sent from the parts server 2. At a step S508, the processor 11 retrieves the following logic table 110 in accordance with the symbols given at the step S502 and the compatibility information given at the step S506. As the retrieved result, if the corresponding following case does not exist in the following logic table 110, the process proceeds to a step S510. The fact that the corresponding following case does not exist implies, for example, the fact that the design change occurs in each of the part A and the part B and each of the design change parts does not have any compatibility. At the step S510, the processor 11 prepares the transmission message including the design change information received from the parts server 2. At a step S520, it outputs to the predetermined terminal and carries out a review instruction.

At a step S512, the processor 11 judges whether or not the re-integrating process based on the design change is necessary, in response to the design change. If the re-integrating process is unnecessary, the system interprets the part number before the design change and the design change part number as the same meaning, and the process proceeds to the step S520. With reference to FIG. 19, the cases of a case 3, a case 6 and a case 10 correspond to the case that the re-integrating process is unnecessary. The system interprets the part number before the design change and the part number after the design change as the same meaning, in accordance with the information of the mutual compatibility assigned at the step S506. At the step S520, the processor 11 outputs the re-confirmation instruction to urge the confirmation of the integration to a predetermined terminal, in accordance with the judgment that the re-integrating (or selling stop) process is unnecessary.

At a step S514, the processor 11 judges whether or not an integration maintaining process is necessary. If the integration (or selling stop) is maintained, the process proceeds to the step S520. At the step S520, the processor 11 outputs the review instruction to urge the confirmation of the integration (or selling stop) maintenance and the integration consideration of the design change part to a predetermined terminal, in accordance with the judgment of the integration maintenance. A case 1, a case 4, a case 5 and a case 8 shown in FIG. 19 correspond to the integration (or selling stop) maintenance. If the integration (or selling stop) maintaining process is unnecessary, the process proceeds to a step S516.

At the step S516, if the integration (or selling stop) maintaining process is unnecessary (the cases of the cases 2, 7 and 9 shown in FIG. 19), the processor 11 releases the integration (or selling stop) condition for the initial setting. Due to this integration release, each of the part A and the part B does not have the setting of the integration (or selling stop). At a step S518, the processor 11, after releasing the settings of the part A and the part B, integrates the part before the design change (for example, the part A) and the design change part (for example, the part A1). After that, at the step S520, the processor 11 outputs: the confirmation instruction to urge the confirmation of the integration; and the consideration instruction to urge the integration consideration of the design change part (for example, the part A1 in the case 1 of FIG. 19) and the corresponding part before the design change (for example, the part B in the case 1 of FIG. 19), to the predetermined terminal.

Since the following of the design change is carried out through such configurations and operations, with regard to the management schedule of the repair part planned at the time of the part design, even if the design change occurs in the part which results in the occurrence of the new part that does not exist in the management schedule, the part and the management schedule can be changed properly and quickly. Also, as the result of the selling stop consideration, with regard to the part which will not be integrated in future because the product on the market can be used instead and in which the selling will be stopped, it is possible to attain by changing the integration in the above-mentioned flowchart to the selling stop.

The following operation will be described below in detail for each following case shown in FIG. 19. The processor 11 of the parts lifetime managing server 1 carries out the judgment to distinguish whether or not the integration or selling stop plan exists in the part corresponding to the design change information sent from the parts server 2 and whether the part corresponds to the pre-integration or post-integration, and then extracts the proper following case from the following logic table 110. Concretely, the processor 11 of the parts lifetime managing server 1 assigns the compatibility information to the design change part in accordance with the design change information sent from the parts server 2. The processor 11 of the parts lifetime managing server 1 extracts the corresponding following case in accordance with the assigned compatibility information and the information of the integration or selling stop stored in the table of the memory 12, and carries out the process corresponding to the number of the extracted case.

If the part corresponding to the design change information sent from the parts server 2 is the pre-integration (the part A) and if the assigned compatibility information is the non-compatibility, the processor 11 of the parts lifetime managing server 1 extracts the case 1. The processor 11 extracting the case 1 prepares the message including: the report for indicating that the design change is performed on the pre-integration part (the part A) and the design change part (the part A1) occurs; and the consideration instruction for urging the consideration as to whether or not the part A1 can be integrated into the post-integration part (the part B), and then outputs to the predetermined terminal. In the case of the case 1, there is not the compatibility between the part A and the part A1. Thus, while the correspondence between the part A and the part B is maintained, the process is performed.

If the part corresponding to the design change information sent from the parts server 2 is the pre-integration (the part A) and if the assigned compatibility information is the high compatibility, the processor 11 extracts the case 2. The processor 11 extracting the case 2 automatically releases the integration of the pre-integration part (the part A) and the post-integration part (the part B), and automatically integrates the pre-integration part (the part A) and the design change part (the part A1) in response to the integration release. Moreover, the processor 11 prepares the message including: the report for indicating that the design change is performed on the pre-integration part (the part A) and the design change part (the part A1) occurs; and the consideration instruction for urging the consideration as to whether or not the part A1 can be integrated into the post-integration part (the part B), and then outputs to the predetermined terminal.

If the part corresponding to the design change information sent from the parts server 2 is the pre-integration (the part A) and if the assigned compatibility information is the high compatibility, the processor 11 extracts the case 3. The processor 11 extracting the case 3 prepares the message including the integration confirmation instruction of the design change part (the part A1) and the post-integration part (the part B) in accordance with the fact that the pre-integration part (the part A) and the design change part (the part A1) have the mutual compatibility, and outputs to the predetermined terminal. The system judges that the pre-integration part (the part A) and the design change part (the part A1) are the same part, in accordance with the information that the pre-integration part (the part A) and the design change part (the part A1) have the mutual compatibility, and then advances the process.

If the part corresponding to the design change information sent from the parts server 2 is the post-integration part (the part B) and if the assigned compatibility information is the non-compatibility, the processor 11 extracts the case 4. The processor 11 extracting the case 4 prepares the message including the report for indicating that the design change is performed on the post-integration part (the part B) and the design change part (the part B1) occurs, and outputs to the predetermined terminal. In the case of the case 4, the part B and the part B1 do not have any compatibility. Thus, while the correspondence between the part A and the part B is maintained, the process is performed.

If the part corresponding to the design change information sent from the parts server 2 is the post-integration part (the part B) and if the assigned compatibility information is the high compatibility, the processor 11 extracts the case 5. The processor 11 extracting the case 5 automatically integrates the post-integration part (the part B) and the design change part (the part B1). Also, the processor 11 prepares the message including: the report for indicating that the design change is performed on the post-integration part (the part B) and the design change part (the part B1); and the integration confirmation instruction of the pre-integration part (the part A) and the design change part (the part B1), and outputs to the predetermined terminal.

If the part corresponding to the design change information sent from the parts server 2 is the post-integration part B (the part B) and if the assigned compatibility information is the mutual compatibility, the processor 11 extracts the case 6. The processor 11 extracting the case 6 prepares the message including the integration confirmation instruction of the design change part (the part B1) and the pre-integration part (the part A) in accordance with the fact that the post-integration part (the part B) and the design change part (the part B1), and outputs to the predetermined terminal. The system judges that the post-integration part (the part B) and the design change part (the part A1) are the same part, in accordance with the information that the post-integration part (the part B) and the design change part (the part B1) have the mutual compatibility, and advances the process.

If the parts corresponding to the design change information sent from the parts server 2 are both of the pre-integration part (the part A) and the post-integration part (the part B) and if the assigned compatibility information are the high compatibility, respectively, the processor 11 extracts the case 7. The processor 11 extracting the case 7 automatically releases the integration of the pre-integration part (the part A) and the post-integration part (the part B), and automatically integrates the pre-integration part (the part A) and the design change part (the part A1) in response to the integration release. At the same time, the processor 11 automatically integrates the post-integration part B (the part B) and the design change part (the part B1). Moreover, the processor 11 prepares the message including: the report for indicating that the design change is performed on the pre-integration part (the part A) and the design change part (the part A1) occurs; the report for indicating that the design change is performed on the post-integration part (the part B) and the design change part (the part B1) occurs; and the consideration instruction for urging the consideration as to whether on not the part A1 can be integrated into the design change part (the part B1) of the post-integration part (the part B), and then outputs to the predetermined terminal.

If the part corresponding to the design change information sent from the parts server 2 is the selling stop part (the part A) and if the assigned compatibility information is the non-compatibility, the processor 11 extracts the case 8. The processor 11 extracting the case 8 prepares the message including: the report for indicating that the design change is performed on the selling stop part (the part A) and the design change part (the part A1) occurs; and the consideration instruction for urging the consideration as to whether or not the selling stop is performed on the part A1 after the elapse of predetermined years, and outputs to the predetermined terminal. In the case of the case 8, the part A and the part A1 do not have any compatibility. Thus, while the selling stop plan of the part A is maintained, the process is performed.

If the part corresponding to the design change information sent from the parts server 2 is the selling stop part (the part A) and if the assigned compatibility information is the high compatibility, the processor 11 extracts the case 9. The processor 11 extracting the case 9 automatically releases the selling stop instruction of the selling stop part (the part A) and automatically integrates the selling stop part (the part A) and the design change part (the part A1) in response to the release of the selling stop. Moreover, the processor 11 prepares the message including: the report for indicating that the design change is performed on the selling stop part (the part A) and the design change part (the part A1) occurs; and the consideration instruction for urging the consideration as to whether or not the selling stop is performed on the part A1, and outputs to the predetermined terminal.

If the part corresponding to the design change information sent from the parts server 2 is the selling stop part (the part A) and if the assigned compatibility information is the mutual compatibility, the processor 11 extracts the case 10. The processor 11 extracting the case 10 prepares the message including: the report for indicating that the design change is performed on the design change part (the part A1) and the design change part (the part A1) occurs, in accordance with the fact that the selling stop part (the part A) and the design change part (the part A1) have the mutual compatibility; and the report for re-confirming the maintenance of the selling stop of the design change part (the part A1), and outputs to the predetermined terminal. The system judges that the selling stop part (the part A) and the design change part (the part A1) are the same part, in accordance with the information that the selling stop part (the part A) and the design change part (the part A1) have the mutual compatibility, and advances the process.

The above-mentioned configurations and operations enable the design change following system in this embodiment to sequentially cope with the part on which the new design change is performed. Also, even when the case with which the usual logic cannot cope is induced, the rapid output of the message for attention evocation enables the part management corresponding to the design change to be executed quickly and properly.

1. A parts lifetime management system comprising:
a parts server which stores a parts database storing a plurality of records corresponding to a plurality of kinds of parts which are commercially available, each of said plurality of records including a part ID to specify a corresponding one of said plurality of kinds; and
a parts lifetime managing server which is connected to said parts server by a communication line and which stores an integration database storing an integration data which relates to a pre-integration part ID, a post-integration part ID and an integration condition, wherein said pre-integration part ID and said post-integration part ID are extracted from among said plurality of part IDs,
wherein when said integration condition is satisfied, said parts life time managing server comprises an updating unit which generates and transmits an update notice to said parts server such that it is notified to said parts server that a supply of a pre-integration part specified by said pre-integration part ID is stopped and said pre-integration part is changed to a post-integration part specified by said post-integration part ID and said parts database is updated.

2. A lifetime management system according to claim 1, wherein said life time managing server requests to input a specified date and a specified period in response to an input of said integration data, and stores said specified date and said specified period correspondently in said integration database, and calculates a date after said specified period from said specified date as an execution date, and outputs said update notice to said parts server on said execution date such that said pre-integration part specified by said pre-integration part ID of said integration data is replaced by said post-integration part specified said post-integration part ID of said integration data.

3. A parts lifetime management system according to claim 2, wherein said lifetime managing server receives a change request of said specified date through said communication line, requests an input of a new specified date and a new specified period in response to a reception of said change request, and stores said new specified date and said new specified period in said integration database, and calculates a date after said new specified period from said new specified date as a new execution date, sets said new execution date as a date when said pre-integration part specified by said pre-integration part ID is changed to said post-integration part specified by said post-integration part ID.

4. A parts lifetime management system according to claim 2, wherein said parts lifetime managing server outputs said post-integration part ID corresponding to said pre-integration part ID stored in said integration database, when said pre-integration part ID stored in said integration database is received from a predetermined terminal through said communication line and said integration condition corresponding to said pre-integration part ID stored in said integration database is met.

5. A parts lifetime management system according to claim 1, wherein said integration database stores with respect to said part ID, a supply period data indicating a supply period for which each of said parts specified by said part ID should be supplied on a market, and
said part ID includes a caution part ID of a caution part that there is a possibility that a supply to a market is stopped before said supply period is expired, and
when an inquiry including said part ID is sent from a predetermined terminal, if said inquired part ID is said caution part ID, said parts server notifies that a part specified by said inquired part ID is said caution part ID, to said predetermined terminal.

6. A parts lifetime management system according to claim 1, wherein said integration data is inputted to said integration database when a design drawing of said parts is released.

7. A parts lifetime management system according to claim 1, wherein said parts are used to repair an automobile, a motorbike, or a general purpose machine of a generator, a tiller, an outboard engine, or a lawn mower.

8. A parts lifetime management system according to claim 1, wherein said integration condition is a time period after a mass production of a product using the part specified by said pre-integration part ID is ended.

9. A parts lifetime management system according to claim 1, wherein said parts lifetime managing server sends an input screen data to an integration terminal to request an input of data when said integration condition is satisfied and executes an integration process using the data inputted from said input screen of said integration terminal, and
said integration process includes at least one of a process invalidating any one of said records having said pre-integration part ID, a process changing said integration condition, and a process deleting said integration data from said integration database.

10. A parts lifetime management system according to claim 1, further comprising:
a changing unit which, when said pre-integration part ID is retrieved from a user terminal through said communication line, sends one of said records including said post-integration part ID corresponding to said retrieved pre-integration part ID.

11. A parts lifetime management system according to claim 1, wherein said integration condition shows that a predetermined period is elapsed.

12. A parts lifetime management system according to claim 1, wherein said updating unit updates said integration data using a design revision data which indicates a design of a part is revised, when said design revision data is inputted to said parts database.

13. A parts lifetime management system according to claim 1, wherein each of said records includes a demand data designating a demand of each one of said parts in a past predetermined period, and
said updating unit collects said demand data when an integration time of said integration condition is met, and updates said integration condition when an amount of said demand is larger than a predetermined quantity.

14. A parts lifetime management system according to claim 1, wherein said parts server stores a design revision database storing design data of parts, and generates a design revision message including data of a part which is stored in said design management database and sends to said parts lifetime managing server when a design of a part is revised, and
said parts lifetime managing server retrieves said integration database in response to a reception of said design revision message, and
said parts lifetime managing server outputs a revision request to revise a correspondence between said pre-integration part ID and said post-integration part ID when said pre-integration part ID including any of design revisal planning parts corresponds to said design revised part.

15. A parts lifetime management system according to claim 14, wherein said design revision message includes interchangeability data indicating whether or not said design revised parts and said design revisal planning parts is interchangeable, and
said parts lifetime managing server updates a correspondence of said pre-integration part ID and said post-integration part ID stored in said integration database using said interchangeability data when said pre-integration part ID or said post-integration part ID indicating said design revisal planning parts corresponding to said design revised parts is found in said integration database.

16. A parts lifetime management system according to claim 1, further comprising:
a client terminal installed in a plurality of service branches and connected to said parts server or said parts lifetime managing server through a wide area network,
wherein said integration database stores a selling stop date set with designating at least one of said pre-integration part ID, a cause of selling stop showing a cause to stop a supply of a part corresponding to said pre-integration part ID in response to a coming of said selling stop date, and a code of a cause generated by coding said cause of selling stop,
said parts server stops a supply of part corresponding to said pre-integration part ID designated in a coming of said selling stop date, and outputs said cause code in response to an inquiry about a part corresponding to stopped said pre-integration part ID from said user terminal, and
said user terminal receives said cause code through said network and outputs it.

17. A parts lifetime management system according to claim 16, wherein said cause code includes an integration cause code and a selling stop cause code, and
said parts lifetime managing server retrieves said integration database in response to an inquiry including said part ID from said client terminal, and
when said post-integration part ID corresponding to said pre-integration part ID which is coincide with said inquired part ID is retrieved, said parts lifetime managing server outputs said post-integration part ID and said integration cause code, and
when said post-integration part ID corresponding to said pre-integration part ID which is coincide with said inquired part ID is not retrieved, said parts lifetime managing server outputs said selling stop cause code, and
said client terminal receives said outputted integration cause code or said selling stop cause code through a wide area network.

18. A parts lifetime management system according to claim 17, wherein said selling stop cause includes a cause of integration and a cause of supply stop,
said parts lifetime managing server retrieves said integration database in response to an inquiry received from said client terminal with said part ID, and
when said post-integration part ID corresponding to said pre-integration part ID coincides with said inquired part ID is retrieved, said parts lifetime managing server outputs said post-integration part ID, said integration cause code, and said cause of integration, and
when said post-integration part ID corresponding to said pre-integration part ID which is coincide with said inquired part ID is not retrieved, said parts lifetime managing server outputs said selling stop cause code and a cause of supply stop, and
said client terminal receives outputted said integration cause code or said selling stop cause code through a wide area network.

19. A parts lifetime management system according to claim 1, wherein said client terminal sends a cause of integration outputting request which corresponds said pre-integration part ID and said cause code through a wide area network to said parts server, and
said parts server executes retrieving on said integration database in response to said cause of integration outputting request and reports said cause of selling stop extracted by said retrieving to said client terminal.

20. A parts lifetime managing method in a parts lifetime management system which comprises:
a network;
a parts server storing a parts database storing a plurality of records each of which corresponds to a kind of parts which are commercially available, and each of said plurality of records includes a part ID which specifies said kind of parts, and an integrated record which is a part of said plurality of records includes data that a supply of a part specified by said part ID is stopped and changed to a supply of an another part; and
a parts lifetime managing server connected to said parts server by said network, and memorizing an integration database storing integration data which includes a pre-integration part ID and an post-integration part ID and a specified date and a specified period correspondingly, and said pre-integration part ID and said post-integration part ID are extracted from said part ID,
said parts lifetime management method comprising:
registering said part ID on said integration database as said pre-integration part ID when a design drawing of parts specified by said part ID is released;
registering said part ID which specifies a part interchangeable to a part specified by stored said pre-integration part ID on said integration database as said post-integration part ID;
registering said specified date and said specified period to said integration database;
calculating a date after said specified period from said specified date as an execution date;
sending said pre-integration ID and said post-integration ID from said parts lifetime managing server to said parts server in response to a coming of said execution date; and
updating said parts database to change a supply of a part specified by received said pre-integration ID to a supply of a part specified by received said post-integration ID.

21. The parts lifetime managing method of a parts lifetime management system according to claim 20 comprising:
sending specified date changing data which reports a change of said specified date from a predetermined terminal to said parts lifetime managing server;
requesting a new specified date and a new specified period from said predetermined terminal to an operator in response to receiving said specific date change data;
storing said new specified date and said new specified period inputted in response to said requesting to said integration database;
calculating a new date after said new specified period from said new specified date as an new execution date; and
storing said new execution date to said integration database.

22. The parts lifetime managing method according to claim 21, further comprising:
inquiring about a part from said predetermined terminal to said parts server;
sending data to said predetermined terminal in a case that said record corresponding to inquired said part is said integrated record, a report which indicates a supply of said part specified by said pre-integration part ID included in said integrated record is stopped and changed to a supply of a part specified by corresponding said post-integration part ID is generated and sent to said predetermined terminal.

23. The parts lifetime managing method according to claim 20, further comprising:
storing supply period data indicating a supplying period of each of said parts to a market to said parts lifetime managing server;
storing a part ID indicating a part whose supply to a market might be stopped before said supplying period is expired as a caution part to said parts server;
storing said caution part in said parts lifetime managing server when a design of said caution part is released;
inquiring about said part from a predetermined terminal; and
replying to said predetermined terminal that inquired said part is said caution part if inquired said part is said caution part.

24. The parts lifetime managing method according to claim 20, wherein a parts server stores a design management database which stores designs of parts,
said parts lifetime management method comprises;
requiring a specified date and a specified period in response to an input of said integration data;
storing inputted said specified date and said specified period correspondingly to said integration database;
calculating a date after said specified period from said specified date as an execution date in response to said storing of said specified date and said specified period;
generating a design revision message reporting a pre-revised parts whose data is stored in said design management database is revised to a post-revised parts;
adding interchangeability data representing an interchangeability of said pre-revised parts and said post-revised parts to said design revision message;
sending said design revision message to said parts lifetime managing server;
retrieving said integration database in response to receiving said design revision message;
changing a relation between said pre-integration part ID and said post-integration part ID in said integration database based on said interchangeability data in the case that as a result of said retrieving, said pre-integration part ID or said post-integration part ID includes said pre-revised parts corresponding to said post-revised parts is found; and
sending an updating request data which requests a relation of said pre-integration part ID and said post-integration part ID to be updated to an operator terminal, in a case that as a result of said retrieving, said pre-integration part ID or said post-integration part ID includes said pre-revised parts corresponding to said post-revised parts is found.

25. The parts lifetime managing method according to claim 24, further comprising:
requesting an approval data which indicates a changing of correspondence of parts is approved or not to said operator terminal when said operator terminal receives said updating request data;
sending said approval data from said operator terminal to said parts lifetime managing server; and
deciding said pre-integration part ID and said post-integration part ID to be changed or not based on said approval data by said parts lifetime managing server.

26. The parts lifetime managing method according to claim 20, wherein a parts server stores a design management database which stores designs of parts,
said operation method further comprises;
inputting a specified date and a specified period and a pre-integration part ID which indicates a kind of said parts, and post-integration part ID which specifies a part interchangeable to a part specified by said pre-integration part ID when a design draft is released;
calculating a date after said specified period from said specified date as an execution date;
stopping a supply of a part specified by said pre-integration part ID in response to a coming of said execution date;
storing a selling stop date corresponds to said pre-integration part ID, a cause of selling stop which explains a cause to stop a supply of parts corresponding to said pre-integration part ID in response to a coming of said selling stop date, and a code of a cause which is generated by coding said cause of selling stop to said parts lifetime managing server;
stopping a supply of part specified by said pre-integration part ID in response to a coming of said selling stop date; and
outputting said cause of selling stop in response to an inquiry about a supply stopped parts.

27. The parts lifetime managing method according to claim 26, wherein said code of a cause includes an integration cause code and a selling stop cause code,
said parts lifetime managing method comprises:
retrieving said integration database in response to an inquiry of a supply stopped part;
outputting said post-integration part ID and said integration cause code in a case that as a result of said retrieving said post-integration part ID corresponding to said part ID of said supply stopped part is found; and
outputting said selling stop cause code in a case that as a result of said retrieving said post-integration part ID corresponding to said part ID of said supply stopped parts is not found.

28. The parts lifetime managing method according to claim 27, wherein said cause of selling stop includes a cause of integration and a cause of supply stop,
said operating method comprising:
retrieving said integration database in response to an inquiry of a supply stopped part;
outputting said post-integration part ID and said cause of integration and said integration cause code in a case that as a result of said retrieving said pre-integration part ID of said supply stopped part is found;
outputting said cause of supply stop and selling stop cause code in a case that as a result of said retrieving said pre-integration part ID of said supply stopped parts is not found; and
outputting a set of said cause of integration and said integration cause code, or a set of said cause of supply stop and said selling stop cause code.
